(19) United States
(12) Patent Application Publication
(10) Pub. No.: US 2008/0059602 A1
(43) Pub. Date: Mar. 6, 2008

(54) Load balancing method for data I/O paths between groups in which multi-path management is employed

(76) Inventors: Mari Matsuda, Yokohama (JP); Akihisa Sato, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/594,210

(22) Filed: Nov. 8, 2006

(30) Foreign Application Priority Data
Aug. 31, 2006 (JP) 2006-235892

(51) Int. Cl. G06F 9/46; G06F 15/167

(52) U.S. Cl. 709/212; 718/105

(57) ABSTRACT

Provided is a load balancing method for a computer system having one or more host computers, one or more storage systems, and a management computer. Each storage system has a physical disk for storing data that is requested by the host computer to be written, and a disk controller for controlling the physical disk. The load balancing method is characterized in that the storage system provides a storage area of the physical disk as one or more logical units to the host computer, and that the management computer calculates the processing amount of a component passed by a logical path, and refers to the calculated processing amount of the component when distributing, to the logical path, I/O issued from the host computer. Accordingly, it is possible to choose which path to use for access appropriately.

### CLAIM OF PRIORITY

The present application claims priority from Japanese patent application P2006-235892 filed on Aug. 31, 2006, the content of which is hereby incorporated by reference into this application.

### BACKGROUND

This invention relates to a computer system having a host computer, a storage system, and a management computer, and particularly to a technique of balancing I/O among paths.

A multi-path computer system in a storage area network (SAN) environment is known. The multi-path computer system includes a storage system and a host computer. The storage system and the host computer are connected over the SAN including a fibre channel switch.

In the multi-path computer system, a logical unit provided by the storage system and the host computer are connected through a plurality of logical paths. The logical path is a path that is made redundant according to the combination of physical paths in a communication route between the host computer and the storage system. The physical path is an I/O path which connects the host computer and the storage system to each other. For example, the I/O path is a SCSI cable or a Fibre cable.

An access method in a multi-path computer system is disclosed in JP 2005-010956 A. According to a technique of JP 2005-010956 A, a host computer chooses logical paths one by one in a round robin manner. The host computer sends I/O to a logical unit in a storage system over the chosen path.

### SUMMARY

In prior art, each host computer in a multi-path computer system chooses which path to use in sending I/O to a logical unit without taking into account I/O that is sent from other host computers. Also ignored by the host computer in determining which path to use for transmission of I/O to a logical unit are the load and performance of channel adapters (CHAs) in a storage system. Therefore, the load may be balanced in some parts of the multi-path computer system but not throughout the overall system.

This invention has been made in view of the problem described above, and it is therefore an object of this invention to provide a computer system in which the load is balanced properly.

According to an exemplary embodiment of this invention, there is provided a method of balancing load in a computer system that has at least one host computer, at least one storage system coupled to the host computer, and a management computer coupled to the host computer, each host computer including a processor, a memory, and an interface, the management computer including a processor, a memory, and an interface, each storage system including a physical disk for storing data that is requested by the host computer to be written, and a disk controller for controlling the physical disk, the method comprising: providing, by the storage system, the host computer with a storage area of the physical disk as at least one logical unit; calculating, by the management computer, a processing amount of a component passed by a logical path serving as an access route from the host computer to the logical unit; and referring, by the management computer, to the calculated processing amount of the component to distribute, to the logical path, I/O issued from the host computer.

According to the representative mode of this invention, the host computer can properly choose which path to use for transmission of I/O. The load is thus balanced throughout the computer system.

### BRIEF DESCRIPTION OF THE DRAWINGS

The present invention can be appreciated by the description which follows in conjunction with the following figures, wherein:

FIG. 1 is a block diagram of a configuration of a computer system according to a first embodiment of this invention;

FIG. 2 is a block diagram showing the configuration of the host computer in the computer system according to the first embodiment of this invention;

FIG. 3 is a block diagram showing the configuration of the management server in the computer system according to the first embodiment of this invention;

FIG. 4 is an explanatory diagram of a unitary device in the computer system according to the first embodiment of this invention;

FIG. 5 is a configuration diagram of the queue size table which is stored in the host computer according to the first embodiment of this invention;

FIG. 6 is a configuration diagram of the host-side path information table which is stored in the host computer according to the first embodiment of this invention;

FIG. 7 is a configuration diagram of the host-side I/O history table which is stored in the host computer according to the first embodiment of this invention;

FIG. 8 is a configuration diagram of the host-side CHA information table which is stored in the host computer according to the first embodiment of this invention;

FIG. 9 is a configuration diagram of the host-side unitary device management table which is stored in the host computer according to the first embodiment of this invention;

FIG. 10 is a configuration diagram of the management server-side path information table which is stored in the management server according to the first embodiment of this invention;

FIG. 11 is a configuration diagram of the management server-side I/O history table which is stored in the management server according to the first embodiment of this invention;

FIG. 12 shows the expected I/O table which is stored in the management server according to the first embodiment of this invention;

FIG. 13 is a configuration diagram of the management server-side CHA information table which is stored in the management server according to the first embodiment of this invention;

FIG. 14 is a configuration diagram of the expected CHA load table which is stored in the management server according to the first embodiment of this invention;

FIG. 15 is a configuration diagram of the management server-side unitary device management table which is stored in the management server according to the first embodiment of this invention;

FIG. 16 is a flow chart for a process of the initialization subprogram which is executed by the host computer according to the first embodiment of this invention;

FIG. 17 is a flow chart for a process of the I/O dispatch subprogram that is executed by the host computer according to the first embodiment of this invention;

FIG. 18 is a flow chart for a process of the queue monitor which is executed by the host computer according to the first embodiment of this invention;

FIG. 19 is a flow chart for the queue process which is executed by the host computer according to the first embodiment of this invention;

FIG. 20 is a flow chart for the queue size update subprogram which is executed by the management server according to the first embodiment of this invention;

FIG. 21 is a flow chart for the queue size calculation process which is executed by the management server according to the first embodiment of this invention;

FIG. 22 is a flow chart for the I/O predicting process which is executed by the management server according to the first embodiment of this invention;

FIG. 23 is a flow chart for the CHA load predicting processing which is executed by the management server according to the first embodiment of this invention;

FIG. 24 is an explanatory diagram of a host information display screen which is displayed on the management server according to the first embodiment of this invention;

FIG. 25 is an explanatory diagram of the path list screen which is displayed on the management server according to the first embodiment of this invention;

FIG. 26 is an explanatory diagram of the service application list screen which is displayed on the management server according to the first embodiment of this invention; and

FIG. 27 is a flow chart for a process of the I/O dispatch subprogram that is executed by the host computer according to the second embodiment of this invention.

### DETAILED DESCRIPTION OF THE PREFERRED EMBODIMENTS

Hereinafter, embodiments of this invention will be described with reference to the accompanying drawings.

### First Embodiment

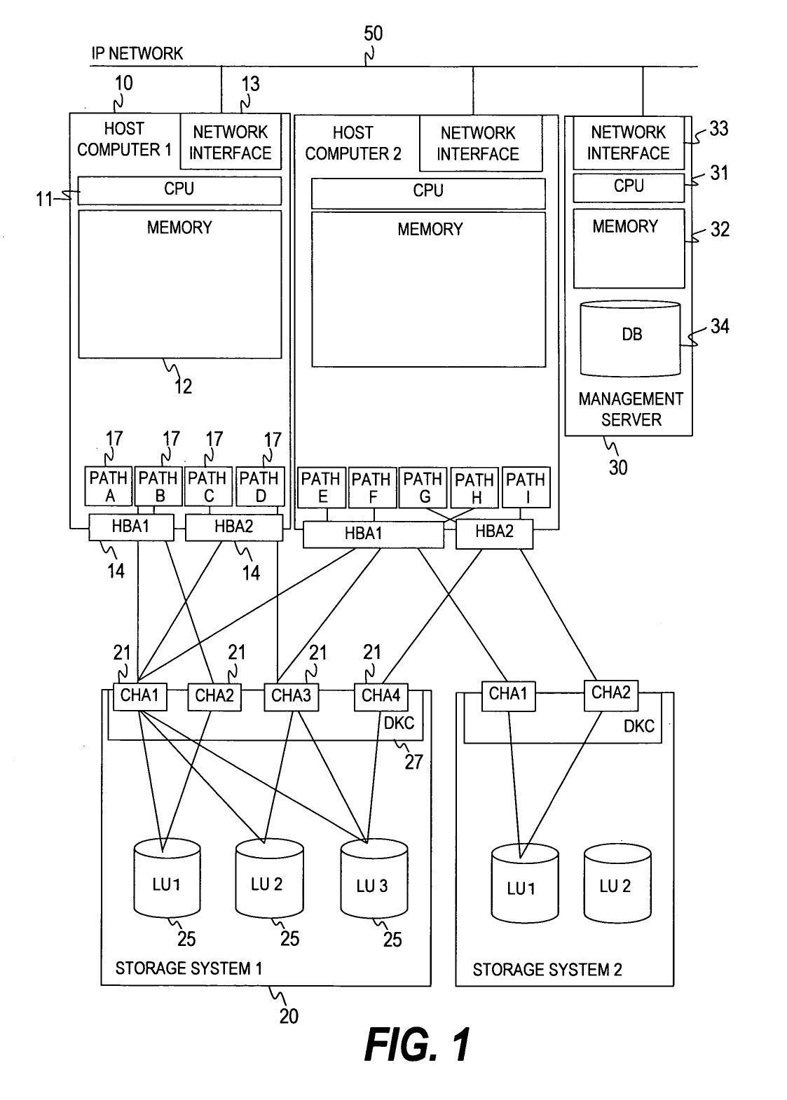

FIG. 1 is a block diagram of a configuration of a computer system according to a first embodiment of this invention.

The computer system includes host computers 10, storage systems 20, and a management server 30.

The host computer 10 and the storage system 20 are connected to each other over a SAN. The SAN is composed of at least one fibre channel switch. The fibre channel switch controls the communication between the host computers 10 and the storage systems 20.

In this embodiment, a logical unit (LU) 25 provided by the storage system 20 and the host computer 10 are connected through a plurality of logical paths (hereinafter, simply referred to as “path”) 17. The path 17 is an access path from the host computer 10 to the LU 25. To be specific, the path 17 is a logical path that is made redundant according to the combination of physical paths in a communication route between the host computer 10 and the storage system 20.

The host computer 10 and the management server 30 are connected to each other over an IP network 50.

Although two host computers 10 are illustrated, the computer system may include any number of host computers 10. In the same way, although two storage systems 20 are illustrated, the computer system may include any number of storage systems 20.

The storage system 20 includes a disk controller (DKC) 27 and a physical disk. The storage system 20 may include a flash memory in place of the physical disk.

The disk controller 27 reads and writes data from/to the physical disk. The disk controller 27 provides a storage area of the physical disk as the logical unit (LU) 25 to the host computer 10.

The disk controller 27 includes at least one channel adapter (CHA) 21. The CHA 21 controls data transfer with the host computer 10. The CHA 21 includes a CPU, a memory, and CHA ports. The CHA port is an interface connected to the SAN. The CHA 21 may include any number of CHA ports.

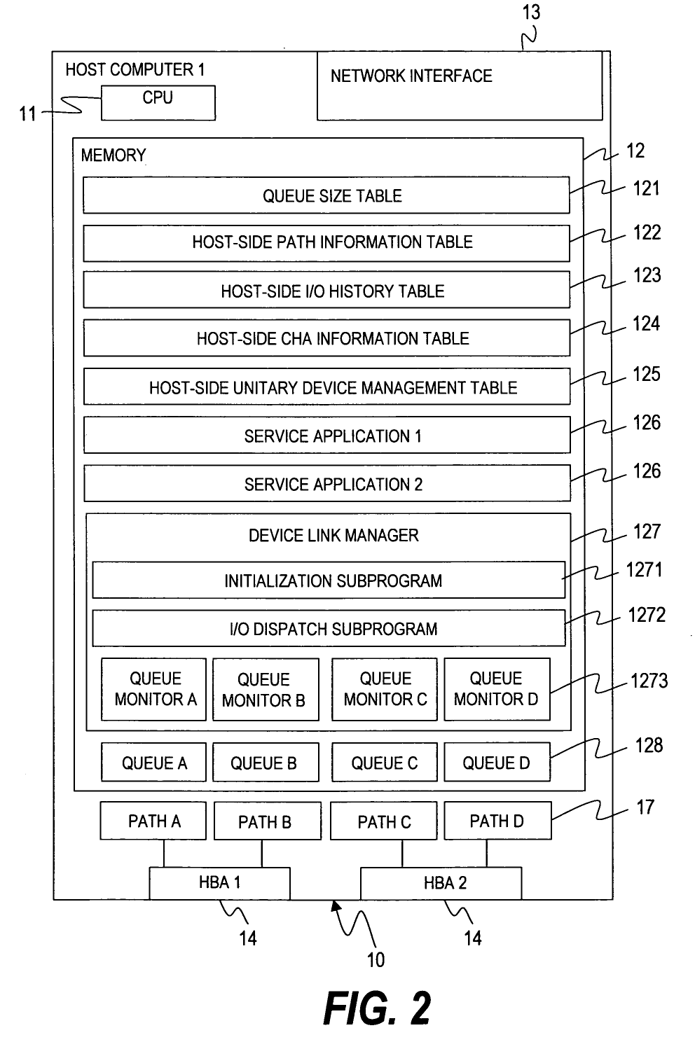

The host computer 10 reads and writes data in the LU 25 provided by the storage system 20. Details of the host computer 10 will be described with reference to FIG. 2.

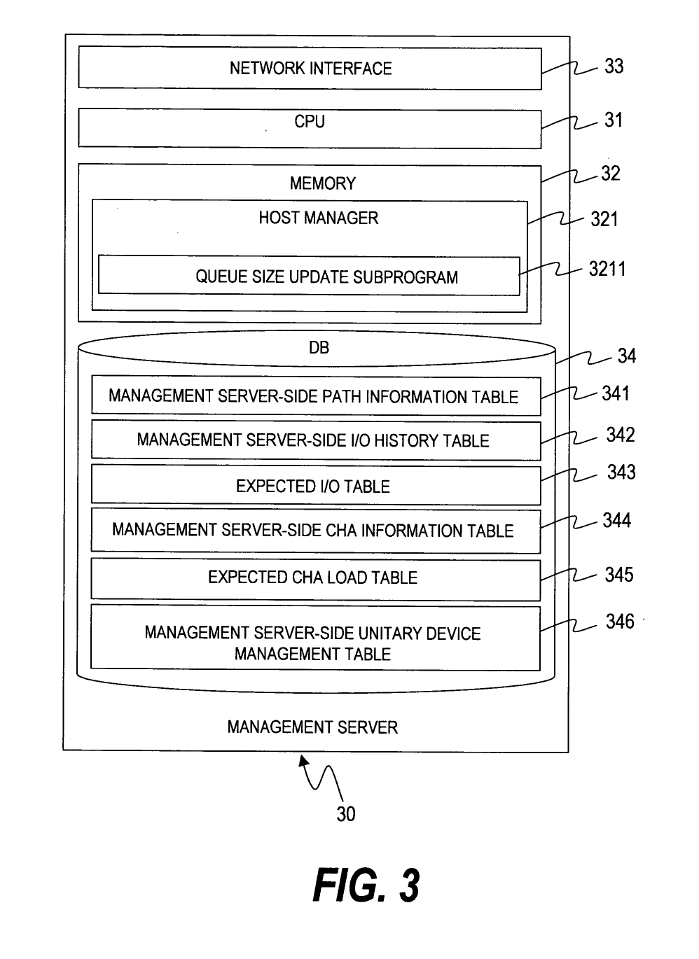

The management server 30 manages the connected host computer 10. Details of the management server 30 will be described with reference to FIG. 3.

FIG. 2 is a block diagram showing the configuration of the host computer 10 in the computer system according to the first embodiment of this invention.

The host computer 10 has a CPU 11, a memory 12, a network interface 13, and a host bus adapter (HBA) 14. One host computer 10 has two HBAs 14 in this explanatory diagram, but the host computer 10 can have as many HBAs 14 as necessary.

The network interface 13 is an interface connected to the IP network 50. The HBA 14 is an interface connected to the SAN. The CPU 11 performs various processes by executing programs stored in the memory 12.

The memory 12 stores programs executed by the CPU 11, information needed by the CPU 11, and the like. To be specific, the memory 12 stores a queue size table 121, a host-side path information table 122, a host-side I/O history table 123, a host-side CHA information table 124, a host-side unitary device management table 125, a service application 126, and a device link manager 127. The memory 12 is partially used as a queue 128.

The queue 128 temporarily stores I/O issued by the service application 126. One queue 128 is associated with one path 17 connected to the host computer 10. In other words, as many queues 128 as the count of paths 17 connected to the host computer 10 are created in the memory 12.

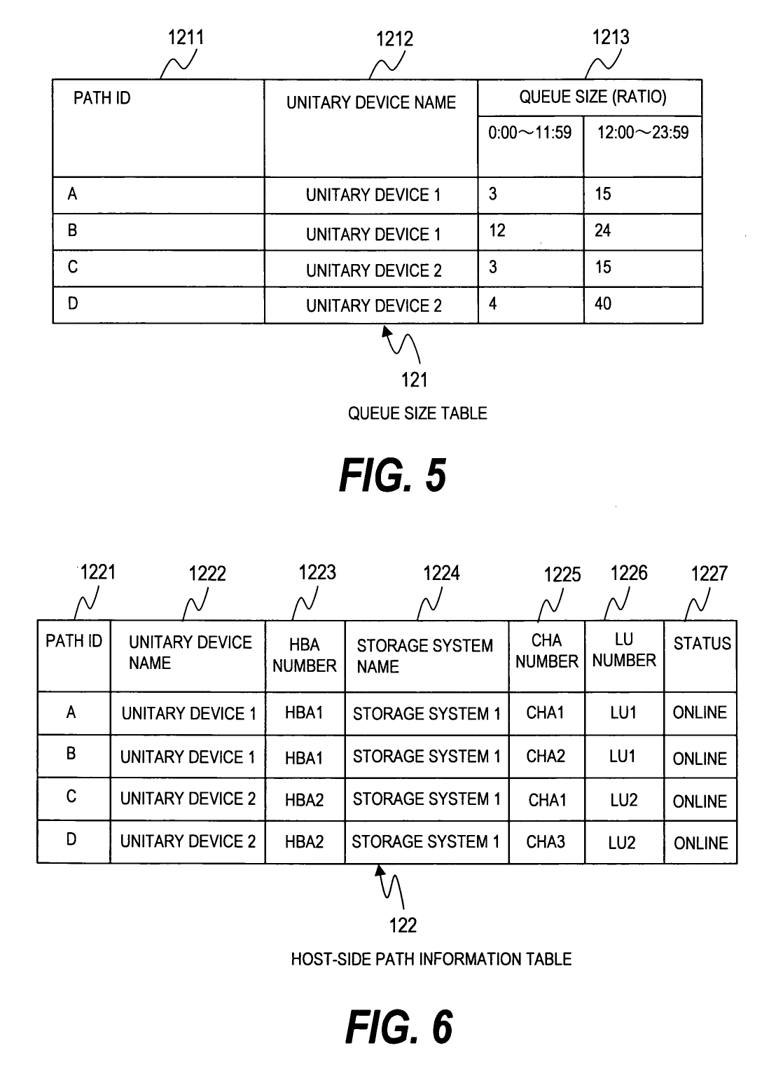

The queue size table 121 shows the capacity of each queue 128 created in the memory 12 of the host computer 10. Details of the queue size table 121 will be described with reference to FIG. 5.

The host-side path information table 122 shows components passed by the path 17 connected to the host computer 10. The components include at least one out of the HBA 14 in the host computer 10, the CHA port 24 in the storage system 20, and the LU25 provided by the storage system 20. The host-side path information table 122 is also used to manage the current status of the path 17 connected to the host computer 10. Details of the host-side path information table 122 will be described with reference to FIG. 6.

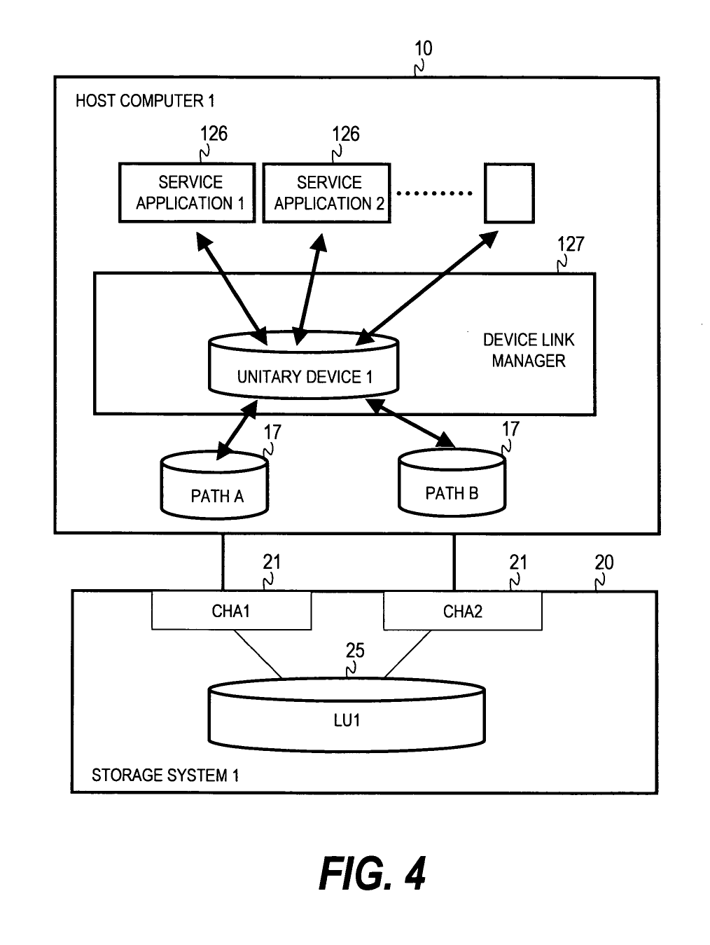

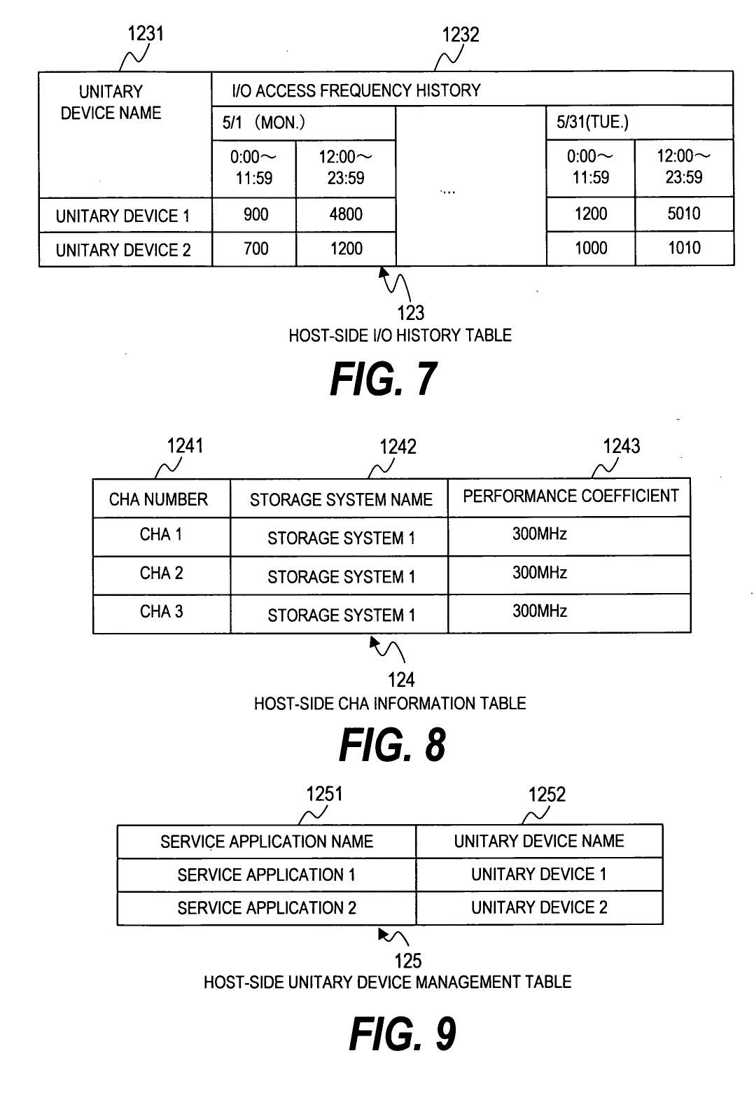

The host-side I/O history table 123 shows the history of the frequency of I/O access from the service application 126 of the host computer 10 to a unitary device. The unitary device, details of which will be described with reference to FIG. 4, is provided by the device link manager 127. Details of the host-side I/O history table 123 will be described with reference to FIG. 7.

The host-side CHA information table 124 shows the performance of the CHA 21 passed by the path 17 connected to the host computer 10. Details of the host-side CHA information table 124 will be described with reference to FIG. 8.

The host-side unitary device management table 125 shows the association between the service application 126 and a unitary device provided to this service application 126. Details of the host-side unitary device management table 125 will be described with reference to FIG. 9.

The service application 126 is a program for executing a certain process. The service application 126 issues I/O to a unitary device. The memory 12 stores two service applications 126 in this explanatory diagram, but may store as many service applications 126 as necessary.

The device link manager 127 is a program for managing the path 17. For example, the device link manager 127 provides redundancy to a physical path which connects the host computer 10 and the storage system 20 to each other, thereby providing the path 17.

The device link manager 127 also has a load balance function. To be specific, the device link manager 127 distributes I/O's to different paths 17 to balance a load on each of the paths.

For example, after transmitting a predetermined number of I/O's by using one path 17, the device link manager 127 selects a next path 17. The device link manager 127 then uses the selected next path 17 to transmit the I/O's. Alternatively, the device link manager 127 may transmit the I/O's to contiguous blocks by using the same path 17. The device link manager 127 refers to the host-side path information table 122 to select the path 17 to be used for transmission of the I/O's.

The device link manager 127 has a path switching function. To be specific, when the device link manager 127 detects a failure occurring in the path 17, the path 17 whose failure has been detected is blocked (placed offline). As a result, the device link manager 127 does not transmit the I/O by using the path 17 whose failure has been detected. Therefore, the device link manager 127 uses an unblocked path 17 to transmit the I/O. The status of the path 17 that is not blocked is referred to as online.

The device link manager 127 executes a path failure detection process (path health check) and thus can detect the failure in the path 17.

To be specific, the device link manager 127 uses a path 17 whose status is desired to be checked to transmit an INQUIRY SCSI command as a failure detection signal (continuity verification signal) to the storage system 20. Then, the device link manager 127 judges the status of the path 17 based on whether or not the failure detection signal has been normally transmitted. To be specific, in the case where the device link manager 127 has normally transmitted the failure detection signal, the device link manager 127 judges that the path 17 is normal. On the other hand, in the case where the device link manager 127 has not normally transmitted the failure detection signal, the device link manager 127 judges that a failure occurs in the path 17.

The device link manager 127 also provides a unitary device to the service application 126. Details of a unitary device will be described with reference to FIG. 4.

The device link manager 127 contains an initialization subprogram 1271, an I/O dispatch subprogram 1272, and a queue monitor 1273.

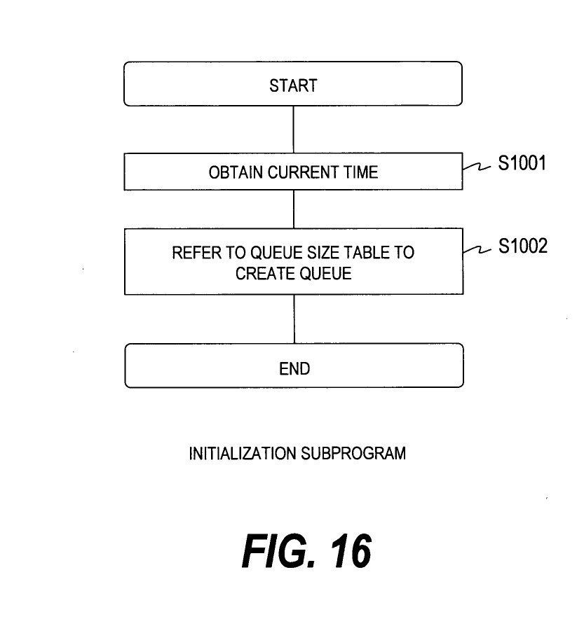

The initialization subprogram 1271 is executed when the device link manager 127 that contains this initialization subprogram 1271 is activated. To be specific, the initialization subprogram 1271 creates, in the memory 12, the queue 1274 for each path 17 connected to the host computer 10 that has this initialization subprogram 1271. Details of the process executed by the initialization subprogram 1271 will be described with reference to FIG. 16.

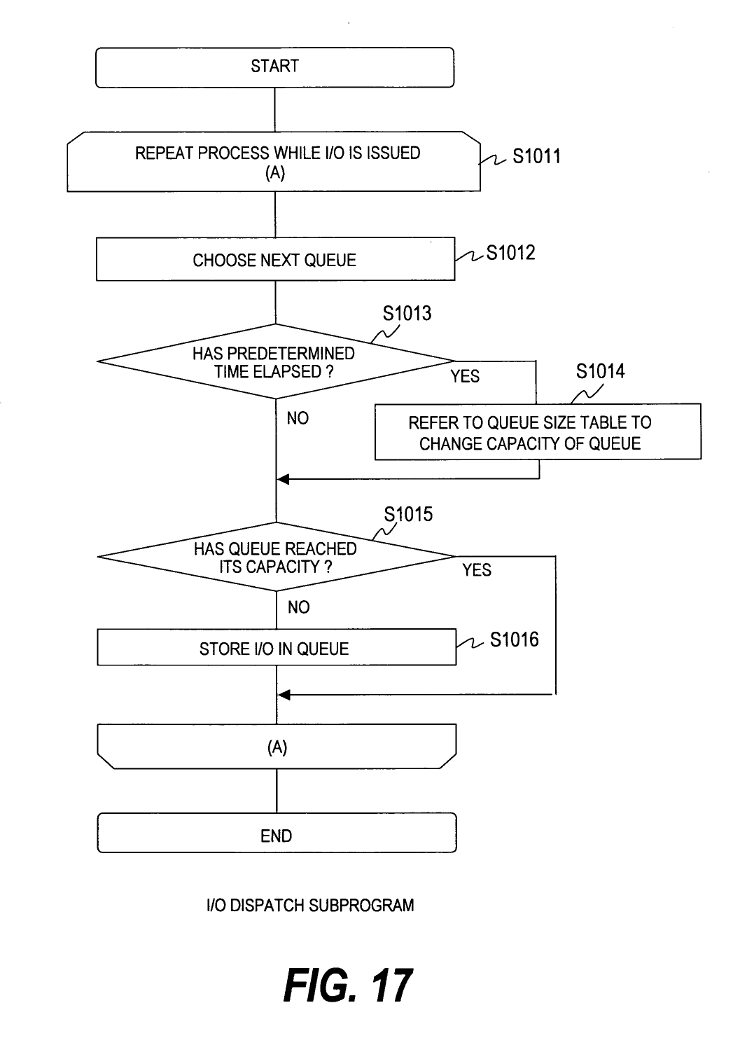

The I/O dispatch subprogram 1272 sends, to the storage system 20, over an appropriate path 17, I/O issued by the service application 126. One I/O dispatch subprogram 1272 is associated with one unitary device. In other words, the device link manager 127 contains as many I/O dispatch subprograms 1272 as the count of unitary devices provided by this device link manager 127. Details of the process executed by the I/O dispatch subprogram 1272 will be described with reference to FIG. 17.

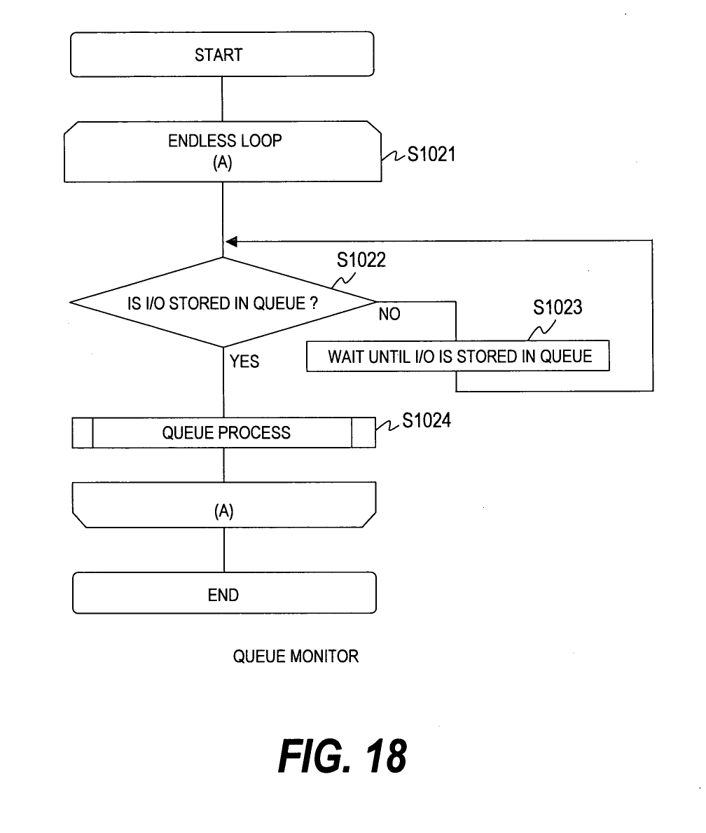

The queue monitor 1273 is a program that monitors the status of the queue 128 created in the memory 12 of the host computer 10 that has this queue monitor 1273. One queue monitor 1273 is associated with one queue 128. In other words, the device link manager 127 contains as many queue monitors 1273 as the count of queues 128 created in the memory 12 of the host computer 10 to which this device link manager 127 belongs. Details of the process executed by the queue monitor 1273 will be described with reference to FIG. 18.

FIG. 3 is a block diagram showing the configuration of the management server 30 in the computer system according to the first embodiment of this invention.

The management server 30 has a CPU 31, a memory 32, a network interface 33, and a database (DB) 34. The network interface 33 is an interface connected to the IP network 50. The CPU 31 performs various processes by executing programs stored in the memory 32.

The memory 32 stores programs executed by the CPU 31, information needed by the CPU 31, and the like. To be specific, the memory 32 stores a host manager 321.

The host manager 321 is a program that unitarily manages information about the connection between the host computer 10 and components of the storage system 20. The host manager 321 contains a queue size update subprogram 3211.

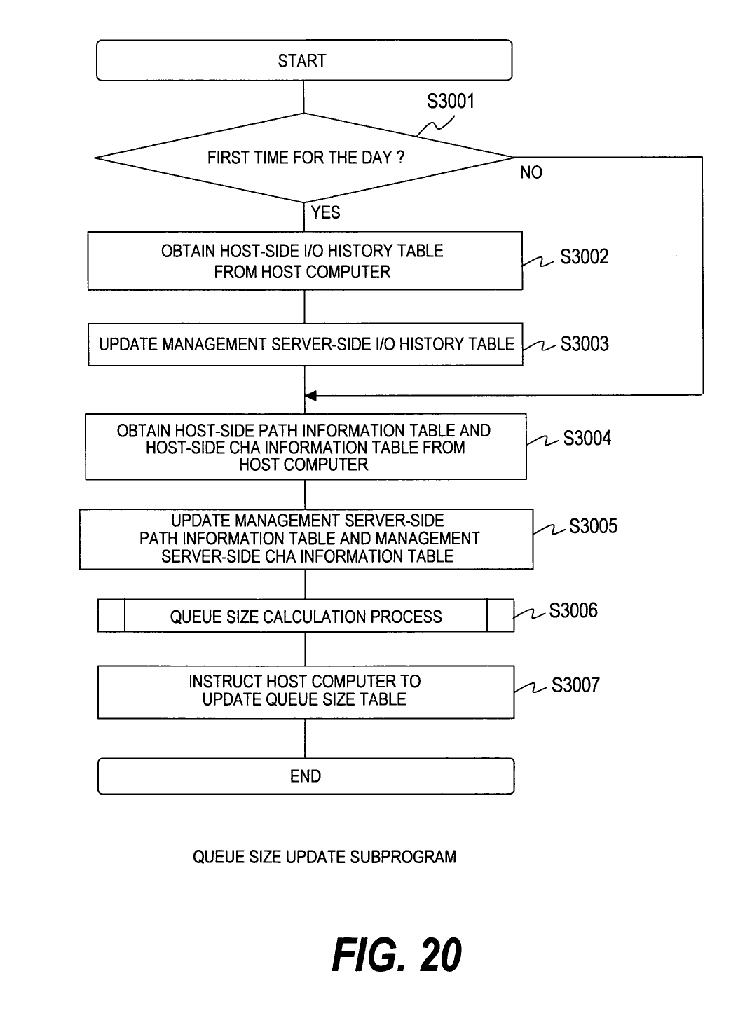

The queue size update subprogram 3211 updates the queue size table 121 stored in the host computer 10. Details of the queue size update subprogram 3211 will be described through a process illustrated in FIG. 20.

The DB 34 stores various types of information. To be specific, the DB 34 stores a management server-side path information table 341, a management server-side I/O history table 342, an expected I/O table 343, a management server-side CHA information table 344, an expected CHA load table 345, and a management server-side unitary device management table 346.

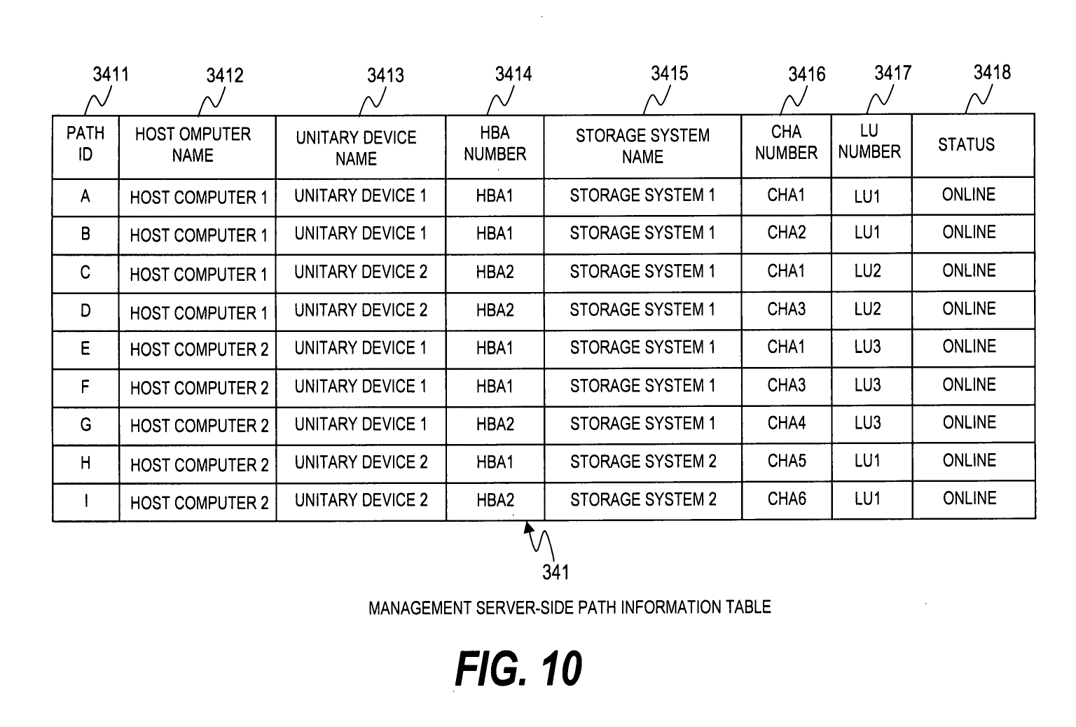

The management server-side path information table 341 shows components passed by the path 17 that is connected to the host computer 10 managed by the management server 30. Details of the management server-side path information table 341 will be described with reference to FIG. 10.

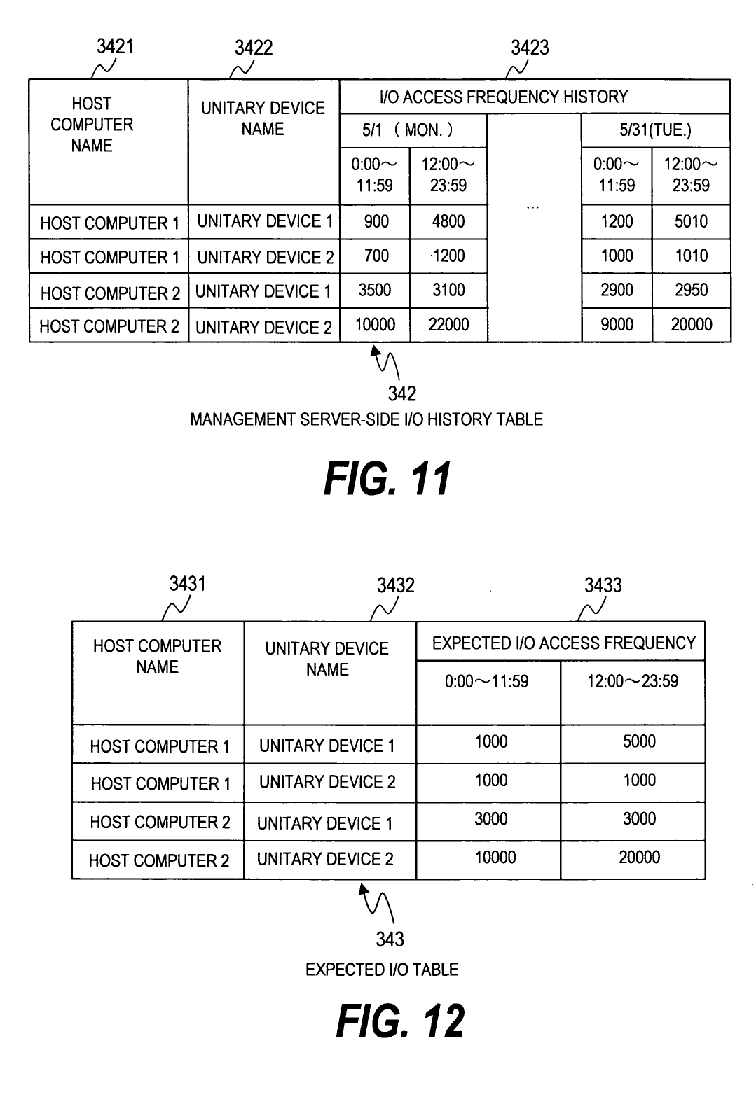

The management server-side I/O history table 342 shows the history of the frequency of I/O access from the service application 126 of the host computer 10 managed by the management server 30 to a unitary device. Details of the management server-side I/O history table 342 will be described with reference to FIG. 11.

The expected I/O table 343 shows a value expected as the frequency of I/O access from the service application 126 of the host computer 10 managed by the management server 30 to a unitary device. Details of the expected I/O table 343 will be described with reference to FIG. 12.

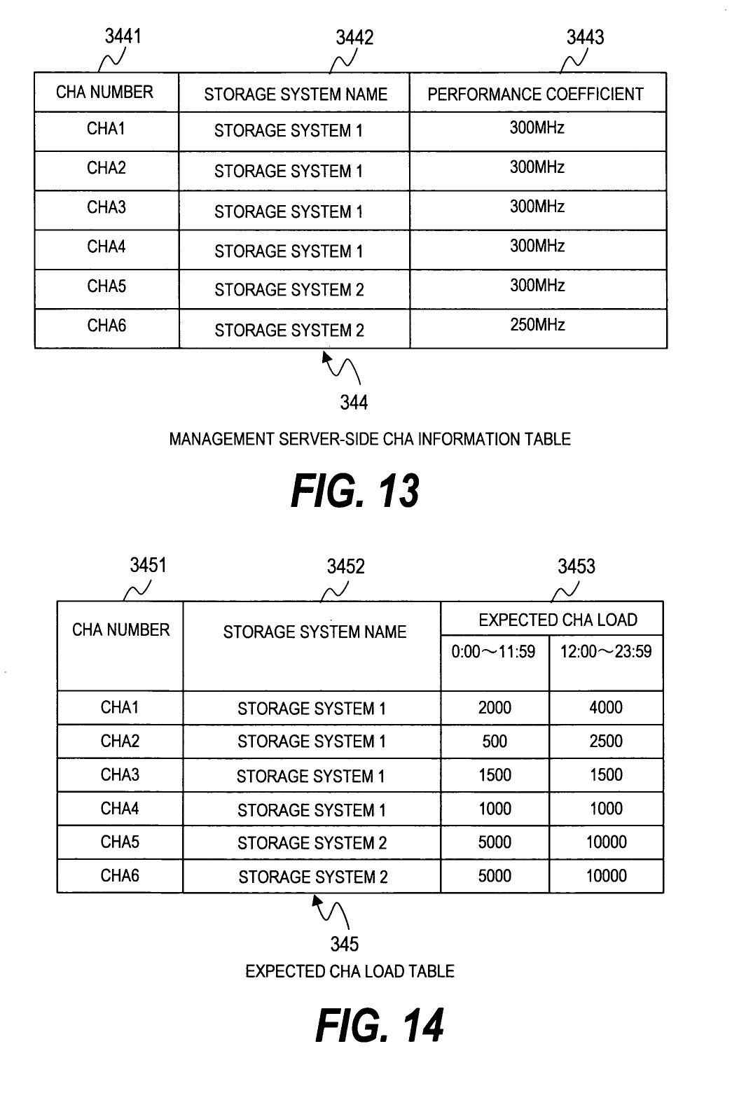

The management server-side CHA information table 344 shows the performance of the CHA 21 passed by the path 17 that is connected to the host computer 10 managed by the management server 30. Details of the management server-side CHA information table 344 will be described with reference to FIG. 13.

The expected CHA load table 345 shows a value expected as the load of the CHA 21 passed by the path 17 that is connected to the host computer 10 managed by the management server 30. Details of the expected CHA load table 345 will be described with reference to FIG. 14.

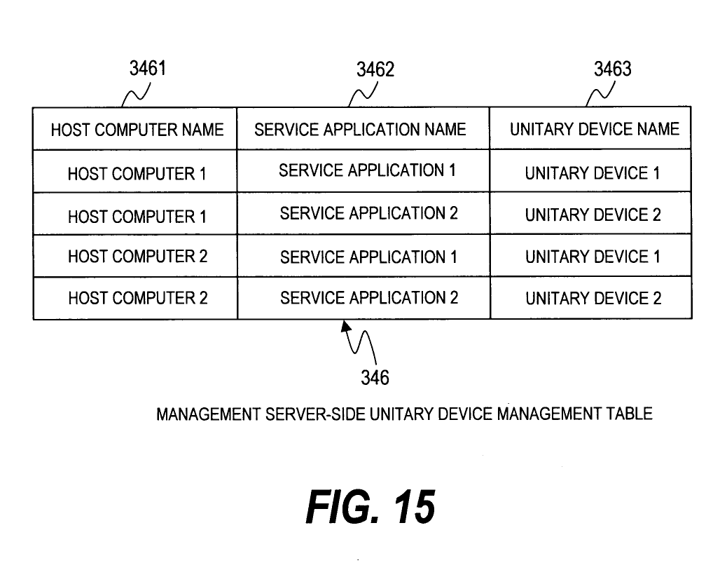

The management server-side unitary device management table 346 shows the association between the service application 126 of the host computer 10 managed by the management server 30 and a unitary device that is provided to this service application 126. Details of the management server-side unitary device management table 346 will be described with reference to FIG. 15.

FIG. 4 is an explanatory diagram of a unitary device in the computer system according to the first embodiment of this invention.

The device link manager 127 of the host computer 10 provides one LU 25 of the storage system 20 as one unitary device to one or more service applications 126. With the unitary device provided, the service application 126 of the host computer 10 accesses the LU 25 of the storage system 20.

The device link manager 127 suitably switches the path 17 used by the service application 126 to access the LU 25. The device link manager 127 thus implements its load balancing function and path switching function without needing the service application 126 to consciously choose which path 17 to use. In other words, the service application 126 can access the LU 25 through an appropriate path 17 by merely issuing I/O to the unitary device.

FIG. 5 is a configuration diagram of the queue size table 121 which is stored in the host computer 10 according to the first embodiment of this invention.

The queue size table 121 contains in each record a path ID 1211, a unitary device name 1212, and a queue size 1213.

The path ID 1211 indicates an identifier unique to each path 17 connected to the host computer 10 that stores this queue size table 121. The unitary device name 1212 indicates an identifier unique to a unitary device that is associated with the path 17 identified by the path ID 1211 of the record.

The queue size 1213 indicates the capacity of the queue 128 that is associated with the path 17 identified by the path ID 1211 of the record. Recorded as the queue size 1213 of the queue size table 121 in FIG. 5 is the ratio of the capacity of the queue 128, not the actual capacity (in bytes) of the queue 128.

The host computer 10 may change the capacity of the queue 128 according to the current time. The queue size table 121 in this case contains, in each record, a plurality of queue sizes 1213 associated with different time slots. The queue size table 121 of FIG. 5 contains a queue size 1213 for a time slot between 0 and 12 o'clock and a queue size 1213 for a time slot between 12 and 24 o'clock.

FIG. 6 is a configuration diagram of the host-side path information table 122 which is stored in the host computer 10 according to the first embodiment of this invention.

The host-side path information table 122 contains in each record a path ID 1221, a unitary device name 1222, an HBA number 1223, a storage system name 1224, a CHA number 1225, an LU number 1226, and a status 1227.

The path ID 1221 indicates an identifier unique to each path 17 connected to the host computer 10 that stores this host-side path information table 122. The unitary device name 1222 indicates an identifier unique to a unitary device that is associated with the path 17 identified by the path ID 1221 of the record.

The HBA number 1223 indicates an identifier unique to the HBA 14 passed by the path 17 that is identified by the path ID 1221 of the record.

The storage system name 1224 indicates an identifier unique to the storage system 20 to which the path 17 that is identified by the path ID 1221 of the record is connected. The CHA number 1225 indicates an identifier unique to the CHA 21 passed by the path 17 that is identified by the path ID 1221 of the record. The host computer 10 identifies the CHA 21 from the storage system name 1224 and the CHA number 1225.

The LU number 1226 indicates an identifier unique to the LU 25 passed by the path 17 that is identified by the path ID 1221 of the record. The host computer 10 identifies the LU 25 from the storage system name 1224 and the LU number 1226.

The status 1227 indicates whether or not the path 17 that is identified by the path ID 1221 of the record is blocked. When the path 17 that is identified by the path ID 1221 of the record is blocked, “offline” is recorded as the status 1227. When the path 17 that is identified by the path ID 1221 of the record is not blocked, on the other hand, “online” is recorded as the status 1227.

FIG. 7 is a configuration diagram of the host-side I/O history table 123 which is stored in the host computer 10 according to the first embodiment of this invention.

The host-side I/O history table 123 contains a unitary device name 1231 and an I/O access frequency history 1232 in each record.

The unitary device name 1231 indicates an identifier unique to each unitary device provided by the device link manager 127. The I/O access frequency history 1232 indicates the history of the frequency of I/O access to the unitary device that is identified by the unitary device name 1231 of the record.

The host-side I/O history table 123 manages the I/O access frequency per given period as a history. The host-side I/O history table 123 of FIG. 7 manages the I/O access frequency per half a day as a history.

A value entered as the I/O access frequency history 1232 may be deleted after a given time elapses. The host-side I/O history table 123 may contain in each record the history of other information related to I/O to a unitary device instead of the I/O access frequency history 1232. An example of other information related to I/O to a unitary device is the amount of I/O data.

FIG. 8 is a configuration diagram of the host-side CHA information table 124 which is stored in the host computer 10 according to the first embodiment of this invention.

The host-side CHA information table 124 contains in each record a CHA number 1241, a storage system name 1242, and a performance coefficient 1243.

The CHA number 1241 indicates an identifier unique to each CHA 21 in the storage system 20. The storage system name 1242 indicates an identifier unique to the storage system 20 having the CHA 21 that is identified by the CHA number 1241 of the record.

The performance coefficient 1243 indicates the performance of the CHA 21 that is identified from the CHA number 1241 and storage system name 1242 of the record. Entered as the performance coefficient 1243 is, for example, the clock count of a CPU in the CHA 21, the capacity of a memory in the CHA 21, the amount of data processed by the CHA 21 per unit time, or the cache hit ratio.

FIG. 9 is a configuration diagram of the host-side unitary device management table 125 which is stored in the host computer 10 according to the first embodiment of this invention.

The host-side unitary device management table 125 contains a service application name 1251 and a unitary device name 1252 in each record.

The service application name 1251 indicates an identifier unique to each service application 126 stored in the host computer 10. The unitary device name 1252 indicates an identifier unique to a unitary device provided to the service application 126 that is identified by the service application name 1251 of the record.

FIG. 10 is a configuration diagram of the management server-side path information table 341 which is stored in the management server 30 according to the first embodiment of this invention.

The management server-side path information table 341 contains in each record a path ID 3411, a host computer name 3412, a unitary device name 3413, an HBA number 3414, a storage system name 3415, a CHA number 3416, an LU number 3417, and a status 3418.

The path ID 3411 indicates an identifier unique to each path 17. The host computer name 3412 indicates an identifier unique to the host computer 10 connected to the path 17 that is identified by the path ID 3411 of the record. The unitary device name 3413 indicates an identifier unique to a unitary device associated with the path 17 that is identified by the path ID 3411 of the record. The management server 30 identifies a unitary device from the host computer name 3412 and the unitary device name 3413.

The HBA number 3414 indicates an identifier unique to the HBA 14 passed by the path 17 that is identified by the path ID 3411 of the record. The management server 30 identifies the HBA 14 from the host computer name 3412 and the HBA number 3414.

The storage system name 3415 indicates an identifier unique to the storage system 20 to which the path 17 that is identified by the path ID 3411 of the record is connected. The CHA number 3416 indicates an identifier unique to the CHA 21 passed by the path 17 that is identified by the path ID 3411 of the record. The management server 30 identifies the CHA 21 from the storage system name 3415 and the CHA number 3416.

The LU number 3417 indicates an identifier unique to the LU 25 passed by the path 17 that is identified by the path ID 3411 of the record. The management server 30 identifies the LU 25 from the storage system name 3415 and the LU number 3416.

The status 3418 indicates whether or not the path 17 that is identified by the path ID 3411 of the record is blocked. When the path 17 that is identified by the path ID 3411 of the record is blocked, “offline” is recorded as the status 3418. When the path 17 that is identified by the path ID 3411 of the record is not blocked, on the other hand, “online” is recorded as the status 3418.

FIG. 11 is a configuration diagram of the management server-side I/O history table 342 which is stored in the management server 30 according to the first embodiment of this invention.

The management server-side I/O history table 342 contains a host computer name 3421, a unitary device name 3422, and an I/O access frequency history 3423 in each record.

The host computer name 3421 indicates an identifier unique to each host computer 10 managed by the management server 30. The unitary device name 3422 indicates an identifier unique to a unitary device provided to the host computer 10 that is identified by the host computer name 3421 of the record.

The I/O access frequency history 3423 indicates the history of the frequency of I/O access to a unitary device that is identified from the host computer name 3421 and unitary device name 3422 of the record.

The management server-side I/O history table 342 manages the I/O access frequency per given period as a history. The management server-side I/O history table 342 of FIG. 7 manages the I/O access frequency per half a day as a history.

A value entered as the I/O access frequency history 3423 may be deleted after a given time elapses. The management server-side I/O history table 342 may contain in each record the history of other information related to I/O to a unitary device instead of the I/O access frequency history 3423. An example of other information related to I/O to a unitary device is the amount of I/O data.

FIG. 12 shows the expected I/O table 343 which is stored in the management server 30 according to the first embodiment of this invention.

The expected I/O table 343 contains in each record a host computer name 3431, a unitary device name 3432, and an expected I/O access frequency 3433.

The host computer name 3431 indicates an identifier unique to each host computer 10 managed by the management server 30. The unitary device name 3432 indicates an identifier unique to a unitary device provided to the host computer 10 that is identified by the host computer name 3431 of the record.

The expected I/O access frequency 3433 indicates the value expected as the frequency of I/O access to a unitary device that is identified from the host computer name 3431 and unitary device name 3432 of the record.

The expected I/O table 343 may contain in each record a plurality of expected I/O access frequencies 3433 that are associated with different time slots. The expected I/O table 343 of FIG. 12 contains in each record an expected I/O access frequency 3433 for a time slot between 0 and 12 o'clock and an expected I/O access frequency 3433 for a time slot between 12 and 24 o'clock. Alternatively, the expected I/O table 343 may contain in each record an expected I/O access frequency 3433 that is associated with day of week or date of month.

FIG. 13 is a configuration diagram of the management server-side CHA information table 344 which is stored in the management server 30 according to the first embodiment of this invention.

The management server-side CHA information table 344 contains in each record a CHA number 3441, a storage system name 3442, and a performance coefficient 3443.

The CHA number 3441 indicates an identifier unique to each CHA 21 in the storage system 20. The storage system name 3442 indicates an identifier unique to the storage system 20 having the CHA 21 that is identified by the CHA number 3441 of the record.

The performance coefficient 3443 indicates the performance of the CHA 21 that is identified from the CHA number 3441 and storage system name 3442 of the record. Entered as the performance coefficient 3443 is, for example, the clock count of the CPU in the CHA 21, the capacity of the memory in the CHA 21, the amount of data processed by the CHA 21 per unit time, or the cache hit ratio.

FIG. 14 is a configuration diagram of the expected CHA load table 345 which is stored in the management server 30 according to the first embodiment of this invention.

The management server-side CHA information table 345 contains in each record a CHA number 3451, a storage system name 3452, and an expected CHA load 3453.

The CHA number 3451 indicates an identifier unique to each CHA 21 in the storage system 20. The storage system name 3452 indicates an identifier unique to the storage system 20 having the CHA 21 that is identified by the CHA number 3451 of the record.

The expected CHA load 3453 indicates the value expected as the load of the CHA 21 that is identified from the CHA number 3441 and storage system name 3442 of the record. Entered as the expected CHA load 3453 is, for example, the expected value of the count of I/O's, which is allocated to the CHA 21.

FIG. 15 is a configuration diagram of the management server-side unitary device management table 346 which is stored in the management server 30 according to the first embodiment of this invention.

The management server-side unitary device management table 346 contains a host computer name 3461, a service application name 3462, and a unitary device name 3463 in each record.

The host computer name 3461 indicates an identifier unique to each host computer 10 managed by the management server 30. The service application name 3462 indicates an identifier unique to the service application 126 stored in the host computer 10 that is identified by the host computer name 3461 of the record. The unitary device name 3463 indicates an identifier unique to a unitary device provided to the service application 126 that is identified by the service application name 3462 of the record.

Now, a process executed in the computer system according to the first embodiment of this invention is described.

FIG. 16 is a flow chart for a process of the initialization subprogram 1271 which is executed by the host computer 10 according to the first embodiment of this invention.

The host computer 10 executes the initialization subprogram 1271 as the device link manager 127 is activated.

The host computer 10 first obtains the current time (S1001).

The host computer 10 next refers to the queue size table 121 to create the queue 128 in the memory 12 (S1002).

To be specific, the host computer 10 extracts the queue size 1213 that is associated with the current time from every record in the queue size table 121. The host computer 10 then calculates the sum of all the values extracted as the queue size 1213.

Next, the host computer 10 chooses records in the queue size table 121 one by one from top to down. The host computer 10 extracts, from each chosen record, the path ID 1211 and the queue size 1213 that is associated with the current time.

The host computer 10 then secures in the memory 12 a storage area that has a capacity corresponding to the extracted queue size 1213. The host computer 10 uses the storage area secured in the memory 12 as the queue 128 that is associated with the path 17 identified by the extracted path ID 1211.

For instance, when the extracted queue size 1213 indicates the actual capacity (in bytes) of the queue 128, the host computer 10 secures in the memory 12 a storage area of a size equal to the extracted queue size 1213.

When the extracted queue size 1213 indicates the capacity ratio of the queue 128 instead of the actual capacity, the host computer 10 obtains the capacity of a storage area to be secured in the memory 12 as follows.

First, the host computer 10 divides the extracted queue size 1213 by the calculated sum of the queue size 1213. In this manner, the host computer 10 obtains the ratio of the capacity of the queue 128 that is associated with the path 17 identified by the extracted path ID 1211 to the total capacity of all the queues 128. The host computer 10 multiplies the obtained ratio by a capacity for a queue, thus obtaining the capacity of a storage area to be secured in the memory 12. A capacity for a queue is the capacity of a storage area of the memory 12 used as any of the queues 128.

Alternatively, the host computer 10 may obtain the capacity of a storage area to be secured in the memory 12 by multiplying the extracted queue size 121 by a given capacity.

The host computer 10 repeats the above process until every chosen record is processed, thereby creating the queue 128 for each path 17 on a one-on-one basis.

The host computer 10 then ends the process of the initialization subprogram 1271.

FIG. 17 is a flow chart for a process of the I/O dispatch subprogram 1272 that is executed by the host computer 10 according to the first embodiment of this invention.

The host computer 10 executes the I/O dispatch subprogram 1272 as the service application 126 issues I/O to the device link manager 127. The host computer 10 executes the I/O dispatch subprogram 1272 for each unitary device separately. The I/O dispatch subprogram 1272 is executed by the host computer 10 concurrently with the queue monitor 1273.

The host computer 10 repeatedly executes the I/O dispatch subprogram 1272 while I/O is kept issued from the service application 126 to the device link manager 127 (S1011). In other words, the host computer 10 ends the I/O dispatch subprogram 1272 as the service application program 126 stops issuing I/O to the device link manager 127.

The host computer 10 first chooses, out of all the queues 128 that are associated with a unitary device, the queue 128 next to the queue 128 that has been chosen in Step S1012 last time (S1012). To be specific, the host computer 10 chooses, out of all the queues 128 that are associated with this unitary device, the queue 128 whose queue ID is immediately larger than that of the queue 128 chosen in Step S1012 last time. When there is no queue 128 whose queue ID is immediately larger that of the queue 128 chosen last time, or when it is the first time Step S1012 is executed, the host computer 10 chooses the queue 128 that is identified by the smallest queue ID out of all the queues 128 that are associated with this unitary device.

The host computer 10 next judges whether or not a given time has passed since Step S1014 was executed last time (S1013). In the case where the given time has not elapsed yet, the host computer 10 proceeds directly to Step S1015.

In the case where the given time has already passed, the host computer 10 refers to the queue size table 121 to judge whether or not the capacity of the queue 128 chosen in Step S1012 needs to be changed.

To be specific, the host computer 10 chooses from the queue size table 121 a record whose path ID 1211 matches the queue ID of the queue 128 chosen in Step S1012. The host computer 10 extracts from the chosen record the queue size 1213 that is associated with the current time.

The host computer 10 next judges whether or not the capacity of the queue 128 chosen in Step S1012 matches a capacity corresponding to the extracted queue size 1213. When the two capacities match, the host computer 10 judges that there is no need to change the capacity of the queue 128, and proceeds directly to Step S1015.

When the two capacities do not match, the host computer 10 judges that the capacity of the queue 128 needs to be changed. Then the host computer 10 secures in the memory 12 a storage area of a capacity corresponding to the extracted queue size 1213. The host computer 10 uses the storage area secured in the memory 12 as the queue 128 chosen in Step S1012. The host computer 10 thus changes the capacity of the queue 128 chosen in Step S1012 (S1014).

Next, the host computer 10 judges whether or not the queue 128 chosen in Step S1012 has been filled to its capacity (S1015). In the case where the chosen queue 128 has been filled up, the host computer 10 immediately returns to Step S1011.

In the case where the chosen queue 128 has not been filled up to its capacity yet, the host computer 10 stores one issued I/O in the queue 128 chosen in Step S1012 (S1016). The host computer 10 then returns to Step S1011.

The host computer 10 distributes issued I/O among the queues 128 in the manner described above. The capacity of each queue 128 is set based on the ratio of I/O allocated to the path 17 that is associated with the queue 128. The host computer 10 can thus allocate issued I/O to an appropriate path 17.

To be specific, the host computer 10 avoids allocating too much I/O to the path 17 where the load is heavy, the path 17 that passes a heavy-load CHA 21, and the path 17 that passes a low-performance CHA 21. The host computer 10 can thus allocate a lot of I/O to the path 17 where the load is light, the path 17 that passes a light-load CHA 21, and the path 17 that passes a high-performance CHA 21.

The host computer 10 is also capable of taking into account the amount of I/O handled by other host computers 10 when allocating I/O.

In the process of the I/O dispatch subprogram 1272 described here, the host computer 10 chooses the queues 128 one by one and stores one issued I/O in the chosen queues 128. Alternatively, the host computer 10 may choose the queues 128 one by one and store more than one issued I/O in the chosen queue 128.

FIG. 18 is a flow chart for a process of the queue monitor 1273 which is executed by the host computer 10 according to the first embodiment of this invention.

The host computer 10 starts the process of the queue monitor 1273 after finishing the process of the initialization subprogram 1271. Once the process is started, the host computer 10 repeatedly carries out steps from Step S1022 to Step S1024 (S1021).

The host computer 10 first judges whether or not the queue 128 monitored by the queue monitor 1273 is storing I/O (S1022).

When there is no I/O stored, the host computer 10 waits until I/O is stored in this queue 128 (S 1023).

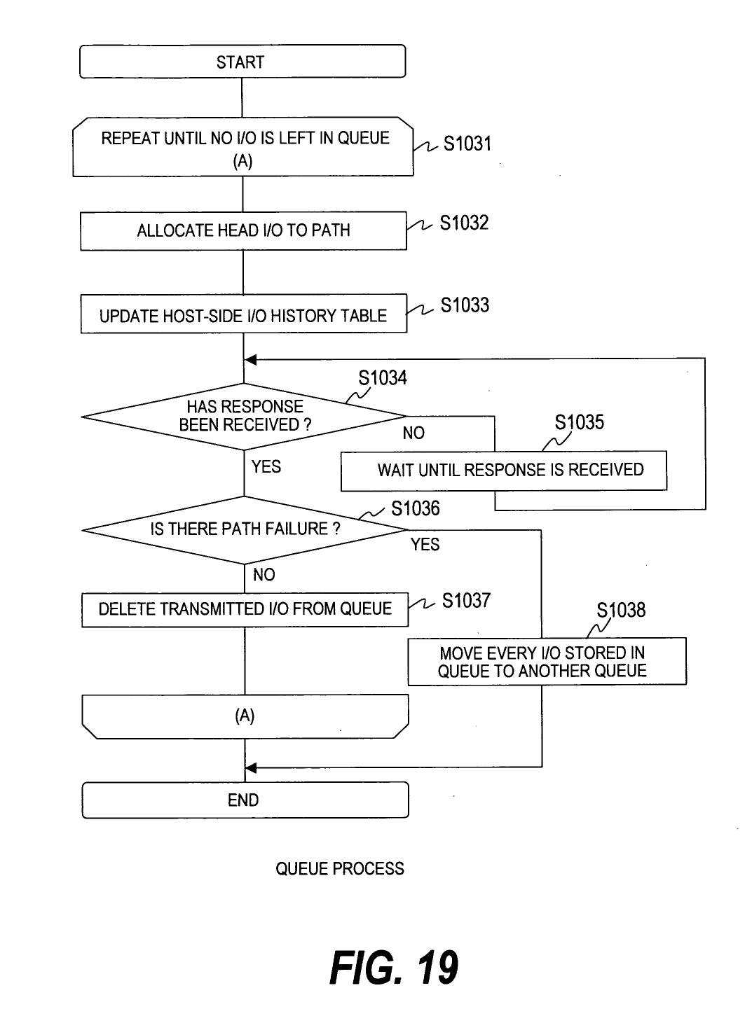

When there is I/O stored, on the other hand, the host computer 10 executes a queue process (S1024). Details of the queue process will be described with reference to FIG. 19.

After finishing the queue process, the host computer 10 returns to Step S1021 and repeats the process of the queue monitor 1273.

FIG. 19 is a flow chart for the queue process which is executed by the host computer 10 according to the first embodiment of this invention.

The queue process is executed in Step S1024 of the process of the queue monitor 1273 which is shown in FIG. 18.

First, the host computer 10 judges whether or not the queue 128 monitored by the queue monitor 1273 is storing I/O. When there is no I/O stored, the host computer 10 terminates the queue process.

When there is I/O stored, the host computer 10 carries out steps from Step S1032 to Step S1038. In other words, the host computer 10 repeats the queue process until no I/O is left in the queue 128 monitored by the queue monitor 1273 (S1031).

The host computer 10 allocates I/O that is stored at the head of the queue 128 monitored by the queue monitor 1273 to the path 17 that is associated with this queue 128 (S1032). In other words, the host computer 10 sends I/O that is stored at the head of the queue 128 to the storage system 20 through the path 17 that is associated with this queue 128.

The host computer 10 next updates the host-side I/O history table 123 (S1033).

To be specific, the host computer 10 identifies which unitary device is associated with the path 17 used in sending the head I/O. The host computer 10 chooses from the host-side I/O history table 123 a record whose unitary device name 1231 matches the identifier of the identified unitary device. From the chosen record, the host computer 10 chooses the I/O access frequency history 1232 that is associated with the current time. The host computer 10 then adds “1” to the chosen I/O access frequency history 1232. The host computer 10 updates the host-side I/O history table 123 in this manner.

In the case where the host-side I/O history table 123 contains in each record an I/O data amount history instead of the I/O access frequency history 1232, the host computer 10 updates the host-side I/O history table 123 through the following process:

First, the host computer 10 measures the data amount of I/O sent. The host computer 10 next identifies which unitary device is associated with the path 17 used in sending the I/O. The host computer 10 chooses from the host-side I/O history table 123 a record whose unitary device name 1231 matches the identifier of the identified unitary device. From the chosen record, the host computer 10 chooses an I/O data amount history that is associated with the current time. The host computer 10 then adds the measured data amount to the chosen I/O data amount history. The host computer 10 updates the host-side I/O history table 123 in this manner.

After updating the host-side I/O history table 123, the host computer 10 judges whether or not a response to the sent I/O has been received from the storage system 20 (S1034). When a response to the I/O has not been received yet, the host computer 10 waits for the reception of the response (S1035).

When a response to the I/O has already been received, the host computer 10 judges from the received response whether or not there is a failure in the path 17 (S1036).

When there is no failure in the path 17, the host computer 10 deletes the sent I/O from the queue 128 (S1037). The host computer 10 then returns to Step S1031 to repeat the queue process.

On the other hand, when there is a failure in the path 17, the host computer 10 moves all I/O stored in the queue 128 monitored by the queue monitor 1273 to other queues 128 (S1038). The queue 128 monitored by the queue monitor 1273 and other queues 128 to which I/O of the monitored queue 128 is moved are associated with the same unitary device.

The host computer 10 then blocks the path 17 that is suffering a failure. To be specific, the host computer 10 chooses from the host-side path information table 122 a record whose path ID 1221 matches the identifier of the path 17 that is suffering a failure. The host computer 10 stores “offline” in the status 1227 of the chosen record.

The host computer 10 thus implements the path switching function. The host computer 10 then ends the queue process.

FIG. 20 is a flow chart for the queue size update subprogram 3211 which is executed by the management server 30 according to the first embodiment of this invention.

The management server 30 regularly runs the queue size update subprogram 3211. The management server 30 may also execute the queue size update subprogram 3211 when requested by the host computer 10 to execute the queue size update subprogram 3211. The host computer 10 requests the management server 30 to run the queue size update subprogram 3211 upon detecting a rapid change in I/O, a failure in the path 17, or the like.

The management server 30 first judges whether or not it is the first time for the day that the queue size update subprogram 3211 is executed (S3001). In the case where the subprogram has already been executed at least once in that day, the management server 30 proceeds directly to Step S3004.

In the case where the queue size update subprogram 3211 is executed for the first time for the day, the management server 30 obtains the host-side I/O history table 123 from every host computer 10 (S3002).

Next, the management server 30 updates the management server-side I/O history table 342 according to all the obtained host-side I/O history tables 123 (S3003).

To be specific, the management server 30 stores, in the host computer name 3421 of the management server-side I/O history table 342, the identifier of each host computer 10 from which the host-side I/O history table 123 has been obtained. The management server 30 then stores the unitary device name 1231 of the obtained host-side I/O history table 123 in the unitary device name 3422 of the management server-side I/O history table 342. In the I/O access frequency history 3423 of the management server-side I/O history table 342, the management server 30 stores the I/O access frequency history 1232 of the obtained host-side I/O history table 123.

The management server 30 next obtains the host-side path information table 122 and the host-side CHA information table 124 from every host computer 10 (S3004).

The management server 30 updates the management server-side path information table 341 according to the obtained host-side path information tables 122.

To be specific, the management server 30 stores, in the path ID 3411 of the management server-side path information table 341, the path ID 1221 of each obtained host-side path information table 122. In the host computer name 3412 of the management server-side path information table 341, the management server 30 stores the identifier of each host computer 10 from which the host-side path information table 122 has been obtained.

Next, the management server 30 stores the unitary device name 1222 of the obtained host-side path information table 122 in the unitary device name 3413 of the management server-side path information table 341. Then, the management server 30 stores the HBA number 1223 of the obtained host-side path information table 122 in the HBA number 3414 of the management server-side path information table 341.

Subsequently, the management server 30 stores the storage system name 1224 of the obtained host-side path information table 122 in the storage system name 3415 of the management server-side path information table 341. Next, the management server 30 stores the CHA number 1226 of the obtained host-side path information table 122 in the CHA number 3416 of the management server-side path information table 341.

Subsequently, the management server 30 stores the LU number 1226 of the obtained host-side path information table 122 in the LU number 3417 of the management server-side path information table 341. Next, the management server 30 stores the status 1227 of the obtained host-side path information table 122 in the status name 3418 of the management server-side path information table 341.

Next, the management server 30 updates the management server-side CHA information table 344 based on the obtained host-side CHA information table 124 (S3005).

To be specific, the management server 30 stores the CHA number 1241 of the obtained host-side CHA information table 124 in the CHA number 3441 of the management server-side CHA information table 344. Next, the management server 30 stores the storage system name 1242 of the obtained host-side CHA information table 124 in the storage system name 3442 of the management server-side CHA information table 344. Next, the management server 30 stores the performance coefficient 1243 of the obtained host-side CHA information table 124 in the performance coefficient 3443 of the management server-side CHA information table 344.

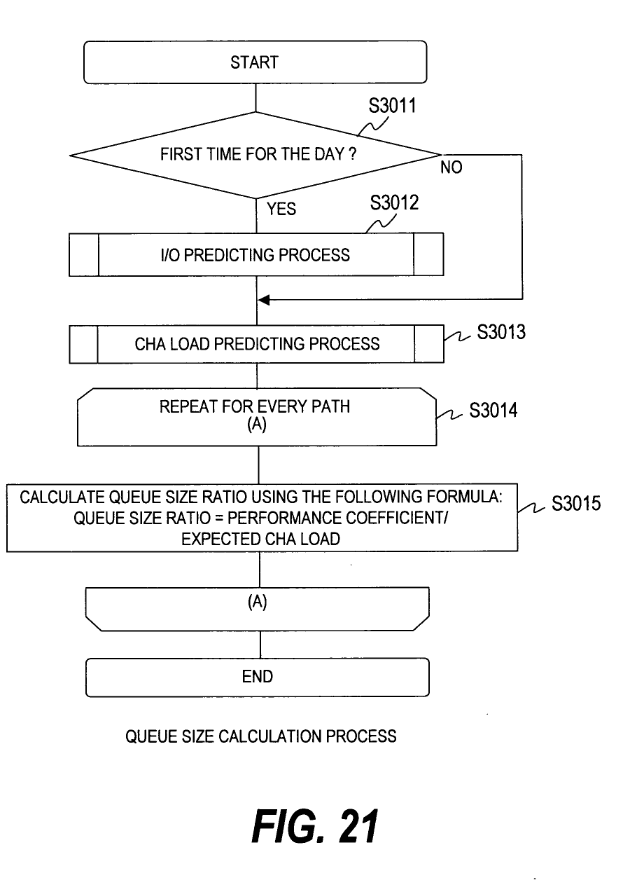

Next, the management server 30 executes a queue size calculation process (S3006), through which the management server 30 calculates the capacity ratio of the queue 128. Details of the queue size calculation process will be described with reference to FIG. 21.

The management server 30 notifies the host computer 10 of the calculated capacity ratio of the queue 128. The management server 30 then instructs the host computer 10 to update the queue size table 121 (S3007). Receiving the instruction, the host computer 10 updates the queue size table 121.

To be specific, the host computer 10 chooses from the queue size table 121 a record whose path ID 1211 matches the identifier of the path 17 that is associated with the queue 128 for which the capacity ratio has been calculated. The host computer 10 stores the notified capacity ratio of the queue 128 in the queue size 1213 in the chosen record.

The management server 30 then ends the process of the queue size update subprogram 3211.

FIG. 21 is a flow chart for the queue size calculation process which is executed by the management server 30 according to the first embodiment of this invention.

The queue size calculation process is executed in Step S3006 of the process of the queue size update subprogram 3211 which is shown in FIG. 20.

The management server 30 first judges whether or not it is the first time for the day that the queue size update subprogram 3211 is executed (S3011). In the case where the subprogram has already been executed at least once in that day, the management server 30 proceeds directly to Step S3013.

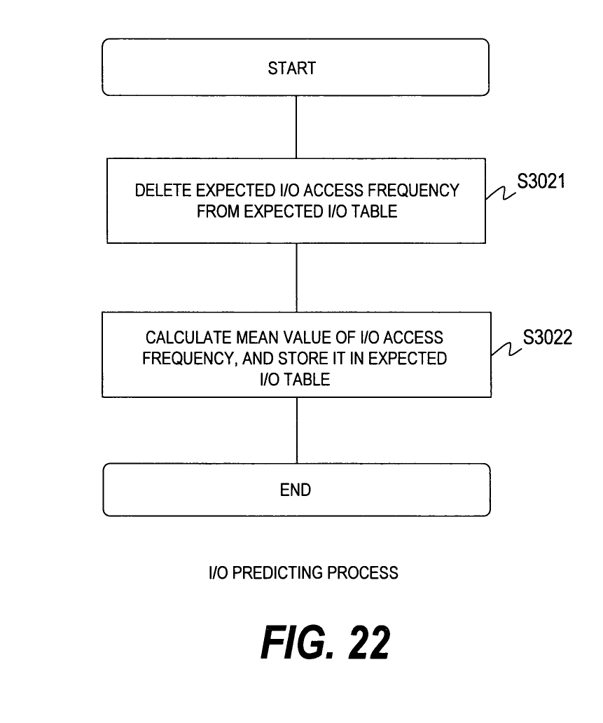

In the case where the queue size update subprogram 3211 is executed for the first time for the day, the management server 30 executes an I/O predicting process (S3012). Through this process, the management server 30 updates the expected I/O table 343. Details of the I/O predicting process will be described with reference to FIG. 22.

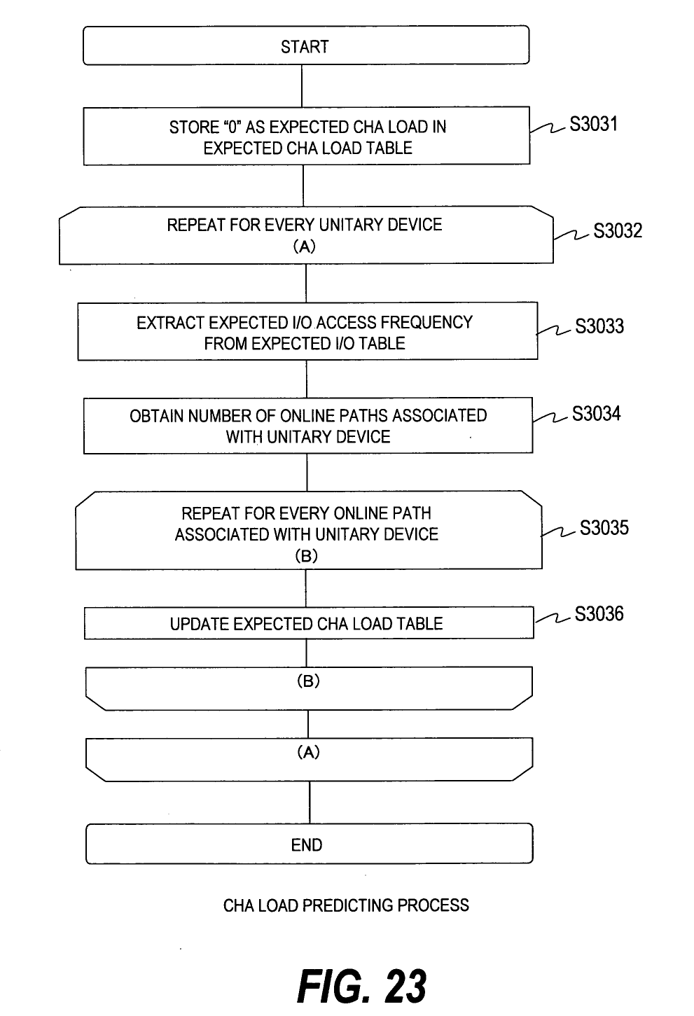

Next, the management server 30 executes a CHA load predicting process (S3013), through which the management server 30 updates the expected CHA load table 345 according to the expected I/O table 343. Details of the CHA load predicting process will be described with reference to FIG. 23.

The management server 30 then chooses one path 17 at a time out of all the paths 17 (S3014). The management server 30 calculates the capacity ratio of the queue 128 that is associated with the chosen path 17.

To be specific, the management server 30 chooses from the management server-side path information table 341 a record whose path ID 3411 matches the identifier of the chosen path 17. From the chosen record, the management server 30 extracts the storage system name 3415 and the CHA number 3416. The management server 30 identifies, from the extracted information, which CHA 21 the chosen path 17 passes.

The management server 30 next selects from the management server-side CHA information table 344 every record whose CHA number 3441 matches the extracted CHA number 3416. Out of the selected records of the management server-side CHA information table 344, the management server 30 chooses a record whose storage system name 3442 matches the extracted storage system name 3415. The management server 30 extracts from the chosen record the performance coefficient 3443.

The management server 30 next selects from the expected CHA load table 345 every record whose CHA number 3451 matches the extracted CHA number 3416. Out of the selected records of the expected CHA load table 345, the management server 30 chooses a record whose storage system name 3452 matches the extracted storage system name 3415. The management server 30 extracts from the chosen record the expected CHA load 3453 that is associated with the current time.

The management server 30 then divides the extracted performance coefficient 3443 by the expected CHA load 3453 extracted, and the capacity ratio of the queue 128 is thus calculated (S3015).

Next, the management server 30 judges whether or not every path 17 has been chosen in Step S3014. When there are still some paths 17 left to be chosen, it means that the calculation of the capacity ratio of the queue 128 is not finished for some paths 17. The management server 30 therefore returns to Step S3014.

On the other hand, when judging that every path 17 has been chosen, the management server 30 ends the queue size calculation process.

FIG. 22 is a flow chart for the I/O predicting process which is executed by the management server 30 according to the first embodiment of this invention.

The I/O predicting process is executed in Step S3012 of the queue size calculation process shown in FIG. 21.

First, the management server 30 deletes information stored as the expected I/O access frequency 3433 in the expected I/O table 343 (S3021).

The management server 30 next calculates an expected I/O access frequency based on the management server-side I/O history table 342.

To be specific, the management server 30 chooses records of the management server-side I/O history table 342 one by one from top to down. The management server 30 repeats the following process until every record is chosen:

The management server 30 extracts from the chosen record the host computer name 3421, the unitary device name 3422 and the I/O access frequency history 3423. The management server 30 calculates the average of all I/O access frequencies registered as the I/O access frequency history 3423 extracted, thereby obtaining an expected I/O access frequency.

In the case where each record of the management server-side I/O history table 342 holds the I/O access frequency histories 3423 for different time slots, the management server 30 calculates an expected I/O access frequency for each time slot by averaging only I/O access frequencies that are associated with the time slot.

The management server 30 may extract from the management server-side I/O history table 342 only the I/O access frequency history 3423 that is associated with the day of the week. Then the management server 30 calculates an expected I/O access frequency by averaging I/O access frequencies that are registered as the I/O access frequency history 3423 extracted.

Next, the management server 30 updates the expected I/O table 343 (S3022).

To be specific, the management server 30 selects from the expected I/O table 343 every record whose host computer name 3431 matches the extracted host computer name 3421. Out of the selected records of the expected I/O table 343, the management server 30 chooses a record whose unitary device name 3432 matches the extracted unitary device name 3422. The management server 30 stores the expected I/O access frequency calculated in the expected I/O access frequency 3433 of the chosen record.

The management server 30 then ends the I/O predicting process.

The management server 30 can employ any method in calculating an expected I/O access frequency. For instance, the management server 30 may set the current I/O access frequency as an expected I/O access frequency.

FIG. 23 is a flow chart for the CHA load predicting processing which is executed by the management server 30 according to the first embodiment of this invention.

The CHA load predicting process is executed in Step S3013 of the queue size calculation process shown in FIG. 21.

First, the management server 30 stores “0” as the expected CHA load 3453 in the expected CHA load table 345 (S3031).

Next, the management server 30 chooses one unitary device at a time out of all the unitary devices (S3032). To be specific, the management server 30 chooses records of the expected I/O table 343 one by one from top to down.

The management server 30 extracts from the chosen record the host computer name 3431, the unitary device name 3432 and the expected I/O access frequency 3433 (S3033). The management server 30 thus extracts the expected I/O access frequency 3433 that is associated with the chosen unitary device.

The management server 30 next obtains how many paths 17 are online out of the paths 17 that are associated with the chosen unitary device (S3034).

To be specific, the management server 30 selects from the management server-side path information table 341 every record whose host computer name 3411 matches the extracted host computer name 3431. Out of the selected records of the management server-side path information table 341, the management server 30 selects every record whose unitary device name 3413 matches the extracted unitary device name 3432. The management server 30 obtains the count of online paths 17 that are associated with that particular unitary device by counting how many records are selected.

Next, the management server 30 chooses, one by one, the online paths 17 that are associated with the unitary device (S3035). To be specific, the management server 30 chooses one of the records selected from the management server-side path information table 341 at a time, starting from the top and proceeding downward.

The management server 30 then updates the expected CHA load table 345 (S3036).

To be specific, the management server 30 divides the predicted I/O access frequency 3433 extracted in Step S3033 by the count of the paths 17 obtained in Step S3034. The management server 30 thus calculates a load-allocated-to-a-chosen-path. The load-allocated-to-a-chosen-path is an expected I/O access frequency that is allocated to the path 17 chosen in Step S3035 out of expected I/O access frequencies that are predicted for the unitary device chosen in Step S3032.

From one of the records selected from the management server-side path information table 341, the management server 30 extracts the storage system name 3415 and the CHA number 3416. The management server 30 then selects from the expected CHA load table 345 every record whose storage system name 3452 matches the extracted storage system name 3415. Out of the selected records of the expected CHA load table 345, the management server 30 chooses a record whose CHA number 3451 matches the extracted CHA number 3416.

The management server 30 adds the load-allocated-to-a-chosen-path calculated to the expected CHA load 3453 of the chosen record.

The management server 30 updates the expected CHA load table 345 in the manner described above.

In the case where the expected I/O table 343 contains in each record the expected I/O access frequencies 3433 for different time slots, the management server 30 calculates a load-allocated-to-a-chosen-path for each time slot. The management server 30 adds the load-allocated-to-a-chosen-path calculated to the expected CHA load 3453 that is associated with a time slot for which this load-allocated-to-a-chosen-path is calculated.

Next, the management server 30 judges whether or not every online path 17 that is associated with the unitary device has been chosen in Step S3035. When some online paths 17 that are associated with the unitary device are still left to be chosen, it means that the management server 30 has not finished processing the unitary device chosen in Step S3032. The management server 30 therefore returns to Step S3035.

In a case where every online path 17 that is associated with the unitary device has already been chosen, the management server 30 finishes processing the unitary device chosen in Step S3032. The management server 30 next judges whether or not every unitary device has been chosen in Step S3032. When there are still some unitary devices left to be chosen, it means that there are unprocessed unitary devices. The management server 30 therefore returns to Step S3032.

In a case where every unitary device has already been chosen, the management server 30 ends the CHA load predicting process.

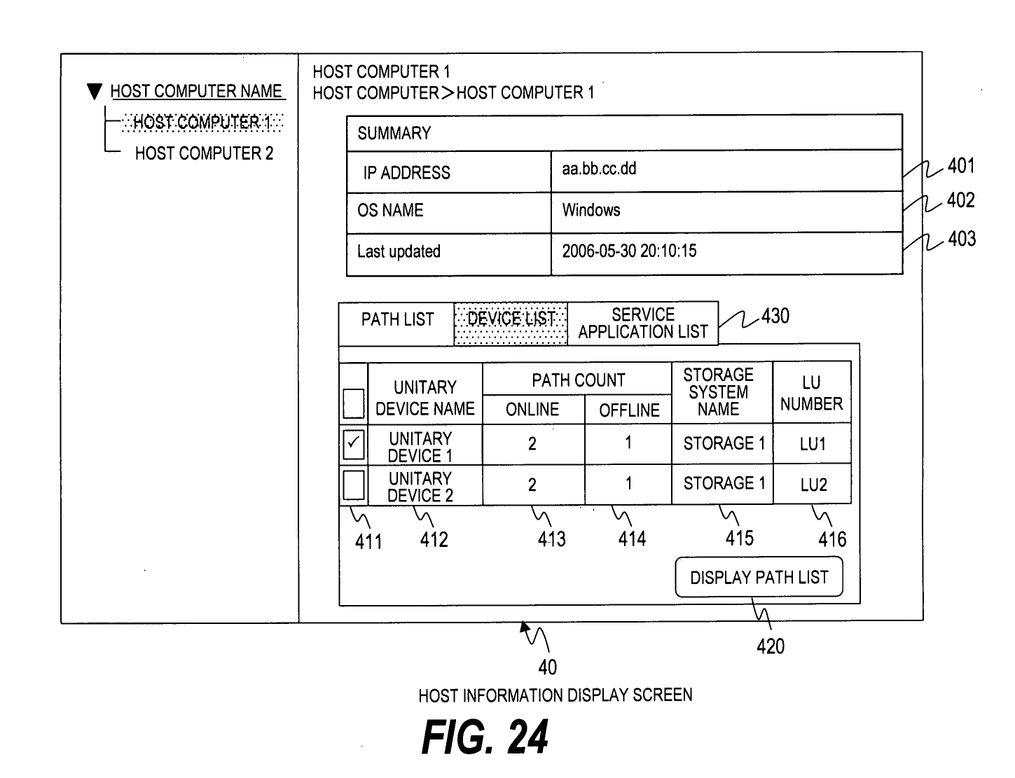

The management server 30 may display a host information display screen shown in FIG. 24 in order to accept instructions from an administrator.

FIG. 24 is an explanatory diagram of a host information display screen 40 which is displayed on the management server 30 according to the first embodiment of this invention.

The management server 30 displays, as the host information display screen 40, information about the host computer 10 that is specified by the administrator.

The host information display screen 40 contains an IP address 401, an OS name 402, a last update date 403, unitary device list information, a “display path list” button 420, and a “display service application list” button 430.

The IP address 401 indicates an identifier assigned to the displayed host computer 10. The OS name 402 indicates the name of an OS that controls the displayed host computer 10. The last update date 403 indicates a date at which data of the displayed host computer 10 is updated last.

The unitary device list information contains in each record a checkbox 411, a unitary device name 412, an online path count 413, an offline path count 414, a storage system name 415 and an LU number 416.

The checkbox 411 indicates whether a unitary device that is identified by the unitary device name 412 of the record is chosen or not. The unitary device name 412 indicates an identifier unique to a unitary device that is provided to the displayed host computer 10.

The online path count 413 indicates how many paths 17 are unblocked out of the paths 17 that are associated with the unitary device identified by the unitary device name 412 of the record. The offline path count 414 indicates how many paths 17 are blocked out of the paths 17 that are associated with the unitary device identified by the unitary device name 412 of the record.

The LU number 416 indicates an identifier unique to the LU 25 that is provided as the unitary device identified by the unitary device name 412 of the record. The storage system name 415 indicates an identifier unique to the storage system 20 that provides the LU 25 identified by the LU number 416 of the record.

As the “display path list” button 420 is operated, the management server 30 creates a path list screen 50 from the management server-side path information table 341, the management server-side CHA information table 344 and the expected CHA load table 345. The management server 30 displays the created path list screen 50.

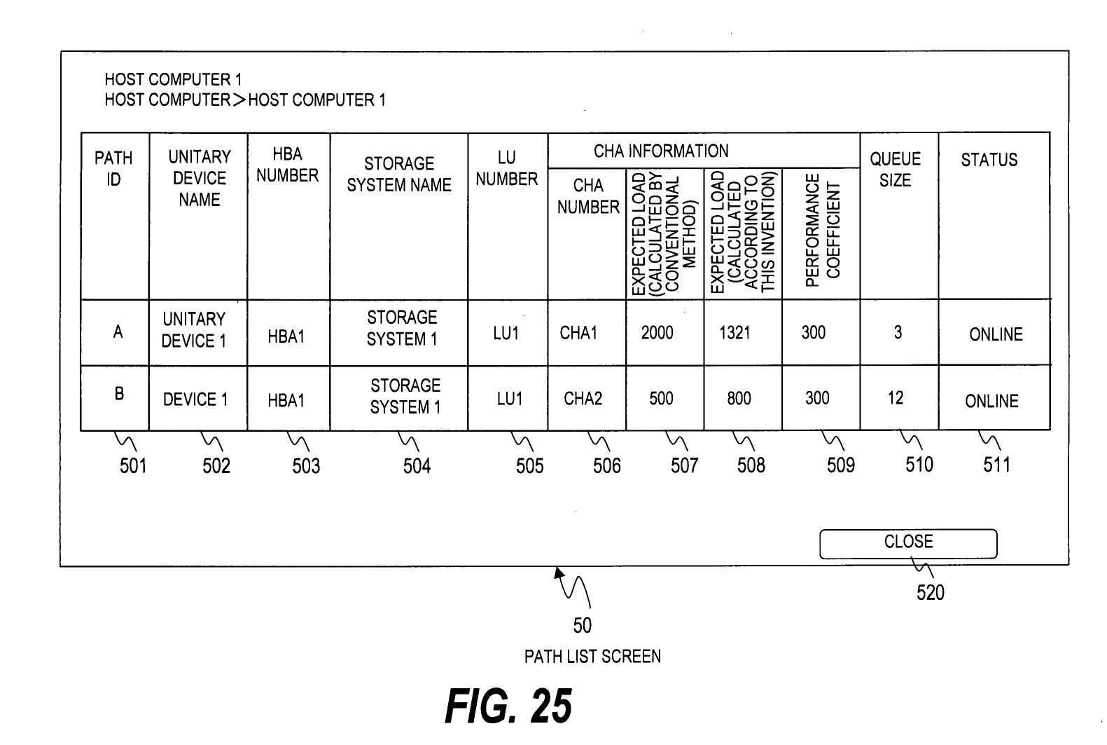

The path list screen 50 contains information about the paths 17 that are associated with a unitary device identified by the unitary device name 412 of a record whose checkbox 411 is checked. Details of the path list screen 50 will be described with reference to FIG. 25.

As the “display service application list” button 430 is operated, the management server 30 creates a service application list screen 60 from the management server-side unitary device management table 346. The management server 30 displays the created service application list screen 60.

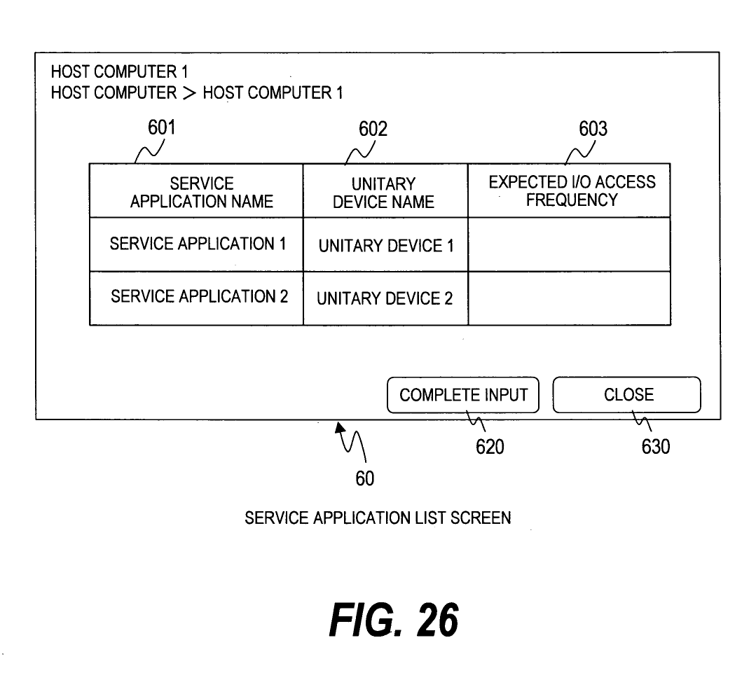

The service application list screen 60 contains information about the service applications 126 that are stored in the host computer 10 specified by the administrator. Details of the service application list screen 60 will be described with reference to FIG. 26.

FIG. 25 is an explanatory diagram of the path list screen 50 which is displayed on the management server 30 according to the first embodiment of this invention.

The path list screen 50 contains information about the paths 17 that are associated with a unitary device chosen on the host information display screen 40. To be specific, each record on the path list screen 50 holds a path ID 501, a unitary device name 502, an HBA number 503, a storage system name 504, an LU number 505, a CHA number 506, an expected load 507 calculated by a conventional method, an expected load 508 calculated according to this invention, a performance coefficient 509, a queue size 510, and a status 511. The path list screen 50 also contains a close button 520.

The path ID 501 indicates an identifier unique to each path 17 that is associated with a unitary device chosen on the host information display screen 40. The unitary device name 502 indicates the name of the unitary device chosen on the host information display screen 40. The HBA number 503 indicates an identifier unique to the HBA 14 passed by the path 17 identified by the path ID 501 of the record.

The storage system name 504 indicates an identifier unique to the storage system 20 to which the path 17 that is identified by the path ID 501 of the record is connected. The LU number 505 indicates an identifier unique to the LU 25 passed by the path 17 that is identified by the path ID 501 of the record.

The CHA number 506 indicates an identifier unique to the CHA 21 passed by the path 17 that is identified by the path ID 501 of the record.

The expected load 507 calculated by a conventional method indicates an expected load that is calculated for the CHA 21 identified by the CHA number 506 of the record when I/O is distributed among the paths 17 in a round robin manner. The expected load 508 according to this invention indicates an expected load that is calculated for the CHA 21 identified by the CHA number 506 of the record when I/O is balanced among the paths 17 according to this embodiment.

The performance coefficient 509 indicates the performance of the CHA 21 identified by the CHA number 506 of the record. The queue size 510 indicates the capacity of the queue 128 that is associated with the path 17 identified by the path ID 501 of the record.

The status 511 indicates whether or not the path 17 that is identified by the path ID 501 of the record is blocked. When the path 17 that is identified by the path ID 501 of the record is blocked, “offline” is recorded as the status 501. When the path 17 that is identified by the path ID 501 of the record is not blocked, on the other hand, “online” is recorded as the status 501.

As the close button 520 is operated, the management server 30 stops displaying the path list screen 50.

FIG. 26 is an explanatory diagram of the service application list screen 60 which is displayed on the management server 30 according to the first embodiment of this invention.

The service application list screen 60 contains information about the service applications 126 that are stored in the host computer 10 specified by the administrator. To be specific, each record of the service application list screen 60 holds a service application name 601, a unitary device name 602, and an expected I/O access frequency 603. The service application list screen 60 also contains a “finished inputting” button 620 and a close button 630.

The service application name 601 indicates an identifier unique to each service application 126 that is stored in the host computer 10 specified by the administrator. The unitary device name 602 indicates an identifier unique to a unitary device provided to the service application 126 that is identified by the service application name 601 of the record. The expected I/O access frequency 603 is a value entered by the administrator as an expected frequency of I/O access to the unitary device that is identified by the unitary device name 602 of the record.

As the “finished inputting” button 620 is operated, the management server 30 updates the expected I/O table 343 according to information entered in an input field of the expected I/O access frequency 603.

To be specific, the management server 30 selects from the expected I/O table 343 every record whose host computer name 3431 matches the identifier of the host computer 10 specified by the administrator. Out of the selected records of the expected I/O table 343, the management server 30 chooses a record whose unitary device name 3432 matches the unitary device name 602. In the expected I/O access frequency 3433 of the chosen record, the management server 30 stores information entered in the input field of the expected I/O access frequency 603.

The management server 30 updates the expected I/O table 343 in the manner described above, and then executes the queue size update subprogram 3211 as shown in FIG. 20. The management server 30 can thus distribute I/O to an appropriate path 17 according to information entered in the input field of the expected I/O access frequency 603.

As the close button 630 is operated, the management server 30 stops displaying the service application list screen 60.

According to this embodiment, the host computer 10 chooses which path to use for I/O transmission while taking into account the load of the path 17, the load of the CHA 21 passed by the path 17, the performance of the CHA 21 passed the path 17, and other factors. The host computer 10 also takes into consideration the amount of I/O sent by other host computers 10 in choosing which path to use for I/O transmission. The host computer 10 can thus distribute issued I/O to an appropriate path 17. The host computer 10 may also consider the load and performance of other components than the CHA 21 passed the path 17 in choosing which path to use for I/O transmission. Other components than the CHA 21 are the HBA 14 in the host computer 10 and a port of a fibre channel switch constituting the SAN.

### Second Embodiment

In a second embodiment of this invention, the host computer 10 keeps storing issued I/O in the same queue 128 until the queue 128 is filled to its capacity.

A computer system according to the second embodiment of this invention has the same configuration as that of the computer system according to the first embodiment which is shown in FIG. 1. A description on the configuration of the computer system according to the second embodiment of this invention is therefore omitted.

A process executed in the computer system according to the second embodiment of this invention is the same as in the computer system according to the first embodiment of this invention, except the process of the I/O dispatch subprogram 1272. The common part of the process will not be described in the second embodiment.

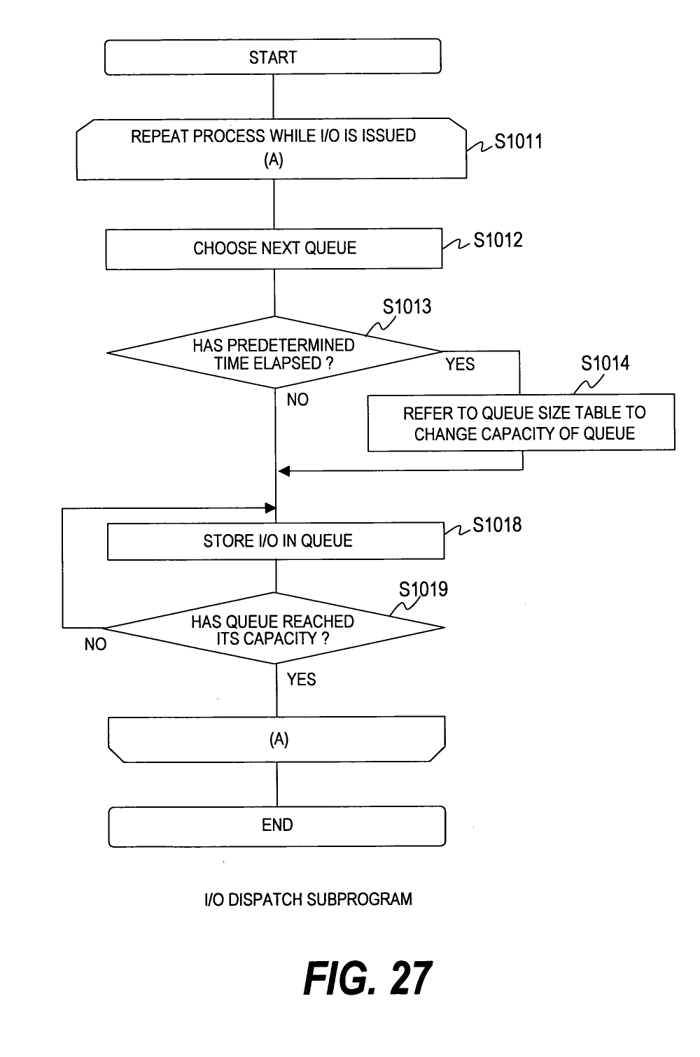

FIG. 27 is a flow chart for a process of the I/O dispatch subprogram 1272 that is executed by the host computer 10 according to the second embodiment of this invention.

The host computer 10 runs the I/O dispatch subprogram 1272 as the service application 126 issues I/O to the device link manager 127. The host computer 10 executes the I/O dispatch subprogram 1272 for each unitary device separately.

The host computer 10 first carries out Steps S 1011 to S 1014. Steps S1011 to S1014 in the second embodiment are the same as those in the process of the I/O dispatch subprogram 1272 of the first embodiment, as shown in FIG. 27, and the repetition of the description is avoided.

The host computer 10 next stores issued I/O in the queue 128 chosen in Step S1012 (S1018).

The host computer 10 then judges whether or not the queue 128 chosen in Step S1012 has reached its capacity (S1019). In a case where the chosen queue 128 has not been filled up yet, the host computer 10 returns to Step S1018. In this way, the host computer 10 keeps storing I/O in the queue chosen in Step S1012 until this queue 128 is filled to its capacity.

When the chosen queue 128 reaches its capacity, the host computer 10 executes the queue monitor 1273 that monitors this chosen queue 128. The host computer 10 then returns to Step S1011.

The host computer 10 of the second embodiment distributes issued I/O to an appropriate queue 128 in the manner described above. The capacity of each queue 128 is set according to the ratio of I/O allocated to the path 17 that is associated with the queue 128. The host computer 10 can thus allocate issued I/O to an appropriate path 17.

To be specific, the host computer 10 avoids allocating too much I/O to the path 17 where the load is heavy, the path 17 that passes a heavy-load CHA 21, and the path 17 that passes a low-performance CHA 21. The host computer 10 thus allocates a lot of I/O to the path 17 where the load is light, the path 17 that passes a light-load CHA 21, and the path 17 that passes a high-performance CHA 21. The host computer 10 is also capable of taking into account the amount of I/O handled by other host computers 10 when allocating I/O.

### Third Embodiment

The host computer 10 according to the first and second embodiments distributes I/O to an appropriate path 17 with the use of the queue 128. In a third embodiment, the host computer 10 distributes I/O to an appropriate path 17 without using the queue 128.

A computer system according to the third embodiment of this invention has the same configuration as that of the computer system according to the first embodiment which is shown in FIG. 1. A description on the configuration of the computer system according to the third embodiment of this invention is therefore omitted. However, the host computer 10 of the third embodiment does not have the queue 128 and the queue monitor 1273.

The host computer 10 in the third embodiment distributes issued I/O among the paths 17 based on the queue size 1213 of the queue size table 121.

To be specific, the host computer 10 chooses one path 17 at a time out of all the paths 17 that are associated with a unitary device. The host computer 10 chooses from the queue size table 121 a record whose path ID 1211 matches the identifier of the chosen path 17. From the record chosen, the host computer 10 extracts the queue size 1213.

The host computer 10 sends as much I/O as indicated by the extracted queue size 1213 over the one path 17 chosen. After that, the host computer 10 chooses the next path 17 and repeats the same process.

The host computer 10 can thus distribute I/O to an appropriate path 17 without using the queue 128 as well as when the queue 128 is used.

Described next is a specific example of the CHA load when a computer system has the configuration shown in FIG. 1.

Here, “1000” is set as both an expected frequency of I/O access to a unitary device 1 and an expected frequency of I/O access to a unitary device 2. “3000” is set as an expected frequency of I/O to a unitary device 3. “10000” is set as an expected frequency of I/O to a unitary device 4. “300” is set as the performance coefficient of the CHAs 21 that are respectively identified by “CHA1 to CHA5”. “250” is set as the performance coefficient of the CHA 21 that is identified by “CHA6”.

The management server 30 first calculates the expected load of each path 17 for when the load is balanced.

To be specific, the management server 30 divides “1000”, which is an expected frequency of I/O access to the unitary device 1, by “2”, which is the count of the paths 17 that are associated with the unitary device 1. The management server 30 thus obtains “500” as the expected load of a path A17 and the expected load of a path B17 for when the load is balanced.

In the same way, the management server 30 divides “1000”, which is an expected frequency of I/O access to the unitary device 2, by “2”, which is the count of the paths 17 that are associated with the unitary device 2. The management server 30 thus obtains “500” as the expected load of a path C17 and the expected load of the path D17 for when the load is balanced.

In the same way, the management server 30 divides “3000”, which is an expected frequency of I/O access to the unitary device 3, by “3”, which is the count of the paths 17 that are associated with the unitary device 3. The management server 30 thus obtains “1000” as the expected load of a path E17, the expected load of a path F17, and the expected load of a path G17 for when the load is balanced.

In the same way, the management server 30 divides “1000”, which is an expected frequency of I/O access to the unitary device 4, by “2”, which is the count of the paths 17 that are associated with the unitary device 4. The management server 30 thus obtains “5000” as the expected load of a path H17 and the expected load of a path I17 for when the load is balanced.

Next, the management server 30 calculates the expected load of each CHA 21 for when the load is balanced.

To be specific, the management server 30 obtains the total expected load of all the paths 17 that passes the CHA 21 identified by “CHA1”. Here, the management server 30 calculates the sum of “500”, which is the expected load of the path A17, “500”, which is the expected load of the path C17, and “1000”, which is the expected load of the path E17. The management server 30 thus obtains “2000” as the expected load of the CHA 21 that is identified by “CHA1”.

The management server 30 next sets “500”, which is the expected load of the path B17, as the expected load of the CHA 21 that is identified by “CHA2”. This is because the path B17 alone passes the CHA 21 that is identified by “CHA2”.

Next, the management server 30 obtains the total expected load of all the paths 17 that pass the CHA 21 identified by “CHA3”. Here, the management server 30 calculates the sum of “500”, which is the expected load of the path D17 and “1000”, which is the expected load of the path F17. The management server 30 thus obtains “1500” as the expected load of the CHA 21 that is identified by “CHA3”.

The management server 30 next sets “1000”, which is the expected load of the path G17, as the expected load of the CHA 21 that is identified by “CHA4”. This is because the path G17 alone passes the CHA 21 that is identified by “CHA4”.

The management server 30 next sets “5000”, which is the expected load of the path H17, as the expected load of the CHA 21 that is identified by “CHA5”. This is because the path H17 alone passes the CHA 21 that is identified by “CHA5”.

The management server 30 next sets “5000”, which is the expected load of the path I17, as the expected load of the CHA 21 that is identified by “CHA6”. This is because the path I17 alone passes the CHA 21 that is identified by “CHA6”.

The management server 30 executes the CHA load predicting process shown in FIG. 23 to calculate the expected load of each CHA 21 for when the load is balanced.

Next, the management server 30 divides the performance coefficient of each CHA 21 by the expected load of the CHA 21. The management server 30 thus determines the amount of I/O to be allocated to the paths 17 that pass this CHA 21.

To be specific, the management server 30 divides “300”, which is the performance coefficient of the CHA 21 identified by “CHA1”, by “2000”, which is the expected load of the CHA 21 identified by “CHA1”.

The management server 30 next divides “300”, which is the performance coefficient of the CHA 21 identified by “CHA2”, by “500”, which is the expected load of the CHA 21 identified by “CHA2”.

The management server 30 next divides “300”, which is the performance coefficient of the CHA 21 identified by “CHA3”, by “1500”, which is the expected load of the CHA 21 identified by “CHA3”.

The management server 30 next divides “300”, which is the performance coefficient of the CHA 21 identified by “CHA4”, by “1000”, which is the expected load of the CHA 21 identified by “CHA4”.

The management server 30 next divides “300”, which is the performance coefficient of the CHA 21 identified by “CHA5”, by “5000”, which is the expected load of the CHA 21 identified by “CHA5”.

The management server 30 next divides “2500”, which is the performance coefficient of the CHA 21 identified by “CHA6”, by “5000”, which is the expected load of the CHA 21 identified by “CHA6”.

The management server 30 determines the amount of I/O to be allocated to the paths 17 that pass the CHA 21 according to a value calculated by dividing the performance coefficient of the CHA 21 by the expected load of this CHA 21. The host computer 10 can thus send I/O to a unitary device over an appropriate path 17.

The host computer 10 distributes I/O to the unitary device 1 between the path A17 and the path B17. The ratio of the count of I/O sent over the path A17 to the count of I/O sent over the path B17 here is “300/2000” “300/500”. This is because the path A17 passes the CHA 21 that is identified by “CHA1” and the path B17 passes the CHA 21 that is identified by “CHA1”.

Accordingly, the ratio of the count of I/O allocated to the path A17 to the total count of I/O to the unitary device 1 is “1/5” whereas the ratio of the count of I/O allocated to the path B17 to the total count of I/O to the unitary device 1 is “4/5”.

In the same way, the host computer 10 distributes I/O to the unitary device 2 between the path C17 and the path D17. The ratio of the count of I/O sent over the path C17 to the count of I/O sent over the path D17 here is “300/2000”:“300/1500”. This is because the path C17 passes the CHA 21 that is identified by “CHA1” and the path D17 passes the CHA 21 that is identified by “CHA1”.

Accordingly, the ratio of the count of I/O allocated to the path C17 to the total count of I/O to the unitary device 2 is “3/7” whereas the ratio of the count of I/O allocated to the path D17 to the total count of I/O to the unitary device 2 is “4/7”.

In the same way, the host computer 10 distributes I/O to the unitary device 3 between the path E17, the path F17, and the path G17. The ratio of the count of I/O sent over the path E17 to the count of I/O sent over the path F17 to the count of I/O sent over the path G7 here is “300/2000”: “300/1500”:“300/1000”. This is because the path E17 passes the CHA 21 that is identified by “CHA1”, the path F17 passes the CHA 21 that is identified by “CHA3” and the path G17 passes the CHA 21 that is identified by “CHA4”.

Accordingly, the ratio of the count of I/O allocated to the path E17 to the total count of I/O to the unitary device 3 is “3/13”. The ratio of the count of I/O allocated to the path F17 to the total count of I/O to the unitary device 3 is “4/13”. The ratio of the count of I/O allocated to the path G17 to the total count of I/O to the unitary device 3 is “6/13”.

In the same way, the host computer 10 distributes I/O to the unitary device 4 between the path H17 and the path I17. The ratio of the count of I/O sent over the path H17 to the count of I/O sent over the path I17 here is “300/5000”:“250/5000”. This is because the path H17 passes the CHA 21 that is identified by “CHA5” and the path I17 passes the CHA 21 that is identified by “CHA6”.

Accordingly, the ratio of the count of I/O allocated to the path H17 to the total count of I/O to the unitary device 4 is “6/11” whereas the ratio of the count of I/O allocated to the path I17 to the total count of I/O to and the unitary device 4 is “5/11”.

I/O is distributed among the paths 17 in the manner described above, and the load is thus balanced among the CHAs 21.

To be specific, the expected load of the CHA 21 identified by “CHA1” is “1321”, which is the sum of the expected load of the path A17, “200” the expected load of the path C17, “429”, and the expected load of the path E15, “692”.

The expected load of the path A17, “200”, is obtained by multiplying “1000”, which is an expected frequency of I/O access to the unitary device 1, by “1/5”, which is the ratio of the count of I/O allocated to the path A17. In the same way, the expected load of the path C17, “429”, is obtained by multiplying “1000”, which is an expected frequency of I/O access to the unitary device 2, by “3/7”, which is the ratio of the count of I/O allocated to the path C17. The expected load of the path E17, “692”, is obtained by multiplying “3000”, which is an expected frequency of I/O access to the unitary device 3, by “3/13”, which is the ratio of the count of I/O allocated to the path E17.

The expected load of the CHA 21 identified by “CHA2” is “800”, which is the expected load of the path B17. The expected load of the CHA 21 identified by “CHA3” is “1494”, which is the sum of the expected load of the path D17, “571” and the expected load of the path F17, “923”. The expected load of the CHA 21 identified by “CHA4” is “1385”, which is the expected load of the path G17.

The expected load of the CHA 21 identified by “CHA5” is “5455”, which is the expected load of the path H17. The expected load of the CHA 21 identified by “CHA6” is “4545”, which is the expected load of the path 117.

As described above, the load is balanced among the CHAs 21 according to the embodiments of this invention. The host computer 10 according to the embodiments of this invention can also take into account the performance and load of the CHA 21 in choosing which path 17 to use for transmission of I/O.

In the first and second embodiments, the management server 30 divides the performance coefficient of each CHA 21 by the expected load of the CHA 21, and uses the obtained value to determine the capacity of the queue 128 that is associated with the path 17 running through this CHA 21. The management server 30 then stores the obtained queue capacity as the queue size 1213 in the queue size table 121.

While the present invention has been described in detail and pictorially in the accompanying drawings, the present invention is not limited to such detail but covers various obvious modifications and equivalent arrangements, which fall within the purview of the appended claims.

What is claimed is:

1. A method of balancing load in a computer system that has at least one host computer, at least one storage system coupled to the host computer, and a management computer coupled to the host computer, each host computer including a processor, a memory, and an interface, the management computer including a processor, a memory, and an interface, each storage system including a physical disk for storing data that is requested by the host computer to be written, and a disk controller for controlling the physical disk, the method comprising:
providing, by the storage system, the host computer with a storage area of the physical disk as at least one logical unit;
calculating, by the management computer, a processing amount of a component passed by a logical path serving as an access route from the host computer to the logical unit; and
referring, by the management computer, to the calculated processing amount of the component to distribute, to the logical path, I/O issued from the host computer.

2. The load balancing method according to claim 1,
wherein the disk controller has a channel adapter coupled to the host computer, and
wherein the component is the channel adapter.

3. The load balancing method according to claim 1, wherein the processing amount is one of a count of I/O processed and an amount of data processed.

4. The load balancing method according to claim 1, further comprising:
measuring, by the host computer, an amount of processing performed on the logical unit;
sending, by the host computer, the measured amount of processing performed on the logical unit to the management computer; and
calculating, by the management computer, the processing amount of the component from the sent amount of processing performed on the logical unit.

5. The load balancing method according to claim 1, further comprising calculating, by the management computer, when the amount of processing performed on the logical unit is entered, the processing amount of the component from the entered amount of processing performed on the logical unit.

6. The load balancing method according to claim 1, further comprising:
obtaining, by the management computer, performance of the component; and
referring, by the management computer, to the calculated processing amount of the component and the obtained performance of the component to distribute, to the logical path, I/O issued from the host computer.

7. The load balancing method according to claim 1, further comprising distributing, by the management computer, I/O issued from the host computer among logical paths by allocating a lot of the I/O issued from the host computer to a logical path that passes a component whose processing amount is found through the calculation to be small.

8. The load balancing method according to claim 1, further comprising:.
creating, by the host computer, a queue for each logical path that is coupled to this host computer;
storing, by the host computer, I/O issued from the host computer in one of the created queues that has a free space;
sending, by the host computer, the I/O stored in the queue to the storage system over the logical path for which this queue is created; and
referring, by the management computer, to the calculated processing amount of the component and setting a size to each queue that is created for each logical path, to distribute I/O issued from the host computer among the logical paths.

9. A computer system comprising:
at least one host computer, each including a processor, a memory, and an interface;
at least one storage system coupled to the host computer, each storage system including a physical disk for storing data that is requested by the host computer to be written, and a disk controller for controlling the physical disk; and
a management computer coupled to the host computer, the management computer including a processor, a memory, and an interface,
wherein the disk controller provides the host computer with a storage area of the physical disk as at least one logical unit,
wherein the management computer calculates a processing amount of a component passed by a logical path serving as an access route from the host computer to the logical unit, and
wherein the management computer refers to the calculated processing amount of the component to distribute, to the logical path, I/O issued from the host computer.

10. The computer system according to claim 9,
wherein the disk controller has a channel adapter coupled to the host computer, and
wherein the component is the channel adapter.

11. The computer system according to claim 9, wherein the processing amount is one of a count of I/O processed and an amount of data processed.

12. The computer system according to claim 9,
wherein the host computer measures an amount of processing performed on the logical unit, and sends the measured amount of processing performed on the logical unit to the management computer, and
wherein the management computer calculates the processing amount of the component from the sent amount of processing performed on the logical unit.

13. The computer system according to claim 9, wherein, when the amount of processing performed on the logical unit is entered, the management computer calculates the processing amount of the component from the entered amount of processing performed on the logical unit.

14. The computer system according to claim 9,
wherein the management computer obtains performance of the component, and
wherein the management computer refers to the calculated processing amount of the component and the obtained performance of the component to distribute, to the logical path, I/O issued from the host computer.

15. The computer system according to claim 9, wherein the management computer distributes I/O issued from the host computer among logical paths by allocating a lot of the I/O issued from the host computer to a logical path that passes a component whose processing amount is found through the calculation to be small.

16. The computer system according to claim 9,
wherein each host computer creates a queue for each logical path that is coupled to this host computer,
wherein I/O issued from this host computer is stored in one of the created queues that has a free space,
wherein the host computer sends the I/O stored in the queue to the storage system over the logical path for which this queue is created, and
wherein the management computer refers to the calculated processing amount of the component when setting a size to each queue that is created for each logical path, and thus distributes I/O issued from the host computer among the logical paths.
